(19) United States
(12) Patent Application Publication
(10) Pub. No.: US 2023/0236383 A1
(43) Pub. Date: Jul. 27, 2023

(54) OPTICAL SYSTEM, OPTICAL APPARATUS AND METHOD FOR MANUFACTURING THE OPTICAL SYSTEM

(71) Applicant: Nikon Corporation, Minato-ku, Tokyo (JP)

(72) Inventor: Mami MURATANI, Tokyo (JP)

(21) Appl. No.: 18/008,967

(22) PCT Filed: Jun. 8, 2021
(86) PCT No.: PCT/JP2021/021709

§ 371 Date: Dec. 7, 2022

(30) Foreign Application Priority Data
Jul. 9, 2020 (JP) 2020-118389

(51) Int. Cl. G02B 7/04; G02B 15/14

(52) U.S. Cl. CPC G02B 7/04; G02B 15/142

(57) ABSTRACT

This optical system (OL) comprises a front group (GA), an aperture stop (S), and a rear group (GB) that are arranged in order from the object side along an optical axis. The rear group (GB) has a focusing lens group (GF1) disposed closest to the object side in the rear group (GB) and having negative refractive power, during focusing, the focusing lens group moves along the optical axis, and the spacing between adjacent lens groups changes, and the following conditional expression is satisfied. 0.50<ST/TL<0.95, where ST is the distance on the optical axis from the aperture stop (S) to an image surface (I), and TL is the total length of the optical system (OL).

### TECHNICAL FIELD

The present invention relates to an optical system, an optical apparatus, and a method for manufacturing the optical system.

### TECHNICAL BACKGROUND

Conventionally, an optical system suitable for a photographing camera, an electronic still camera, a video camera and the like have been proposed (for example, see Patent literature 1). For such an optical system, there is a demand for suppressing fluctuation in angle of view upon focusing.

### PRIOR ARTS LIST

### Patent Document

Patent literature 1: Japanese Laid-Open Patent Publication No. 2011-197471A

### SUMMARY OF THE INVENTION

An optical system according to the present invention consists of, in order from an object on an optical axis: a front group; an aperture stop; and a rear group, wherein the rear group comprises a focusing lens group that is disposed closest to the object in the rear group, and has a negative refractive power, upon focusing, the focusing lens group moves on the optical axis, and distances between lens groups adjacent to each other change, and the following conditional expression is satisfied,

0.50<ST/TL<0.95

where ST: a distance from the aperture stop to an image surface on the optical axis, and

TL: an entire length of the optical system.

An optical apparatus according to the present invention comprises the optical system described above.

A method for manufacturing an optical system consisting of, in order from an object on an optical axis: a front group; an aperture stop; and a rear group according to the present invention, comprises a step of disposing the front group, the aperture stop and the rear group in a lens barrel so that;

the rear group comprises a focusing lens group that is disposed closest to the object in the rear group, and has a negative refractive power, upon focusing, the focusing lens group moves on the optical axis, and distances between lens groups adjacent to each other change, and the following conditional expression is satisfied,

0.50<ST/TL<0.95

where ST: a distance from the aperture stop to an image surface on the optical axis, and

TL: an entire length of the optical system.

### BRIEF DESCRIPTION OF THE DRAWINGS

FIG. 1 shows a lens configuration of an optical system according to First Example.

FIGS. 2A and 2B are various aberration graphs of the optical system according to First Example upon focusing on infinity and upon focusing on a short distance object.

FIG. 3 shows a lens configuration of an optical system according to Second Example.

FIGS. 4A and 4B are various aberration graphs of the optical system according to Second Example upon focusing on infinity and upon focusing on a short distance object.

FIG. 5 shows a lens configuration of an optical system according to Third Example.

FIGS. 6A and 6B are various aberration graphs of the optical system according to Third Example upon focusing on infinity and upon focusing on a short distance object.

FIG. 7 shows a lens configuration of an optical system according to Fourth Example.

FIGS. 8A and 8B are various aberration graphs of the optical system according to Fourth Example upon focusing on infinity and upon focusing on a short distance object.

FIG. 9 shows a lens configuration of an optical system according to Fifth Example.

FIGS. 10A and 10B are various aberration graphs of the optical system according to Fifth Example upon focusing on infinity and upon focusing on a short distance object.

FIG. 11 shows a lens configuration of an optical system according to Sixth Example.

FIGS. 12A and 12B are various aberration graphs of the optical system according to Sixth Example upon focusing on infinity and upon focusing on a short distance object.

FIG. 13 shows a lens configuration of an optical system according to Seventh Example.

FIGS. 14A and 14B are various aberration graphs of the optical system according to Seventh Example upon focusing on infinity and upon focusing on a short distance object.

FIG. 15 shows a lens configuration of an optical system according to Eighth Example.

FIGS. 16A and 16B are various aberration graphs of the optical system according to Eighth Example upon focusing on infinity and upon focusing on a short distance object.

FIG. 17 shows a configuration of a camera that includes the optical system according to the present embodiment.

FIG. 18 is a flowchart showing a method for manufacturing the optical system according to the present embodiment.

### DESCRIPTION OF THE EMBODIMENTS

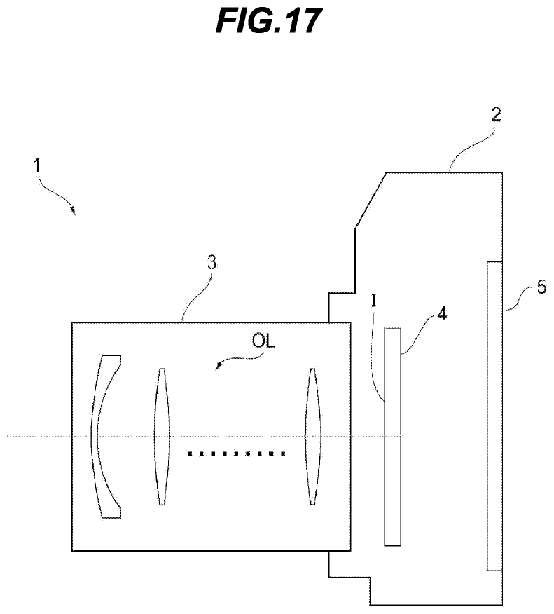

Hereinafter, a preferred embodiment according to the present invention is described. First, a camera (optical apparatus) that includes an optical system according to the present embodiment is described with reference to FIG. 17. As shown in FIG. 17, the camera 1 includes a main body 2, and a photographing lens 3 attached to the main body 2. The main body 2 includes an image-pickup element 4, a main body controller (not shown) that controls the operation of the digital camera, and a liquid crystal screen 5. The photographing lens 3 includes: an optical system OL that includes a plurality of lens groups; and a lens position control mechanism (not shown) that controls the position of each lens group. The lens position control mechanism includes: sensors that detect the positions of the lens groups; motors that move the lens groups forward and backward on the optical axis; and a control circuit that drives the motors.

Light from a subject is collected by the optical system OL of the photographing lens 3, and reaches an image surface I of the image-pickup element 4. The light having reached the image surface I from the subject is photoelectrically converted by the image-pickup element 4 into digital image data, which is recorded in a memory, not show. The digital image data recorded in the memory can be displayed on the liquid crystal screen 5 in response to the operation of a user. Note that the camera may be a mirrorless camera, or a single-lens reflex camera that includes a quick return mirror. The optical system OL shown in FIG. 17 is the schematically shown optical system included in the photographing lens 3. The lens configuration of the optical system OL is not limited to this configuration.

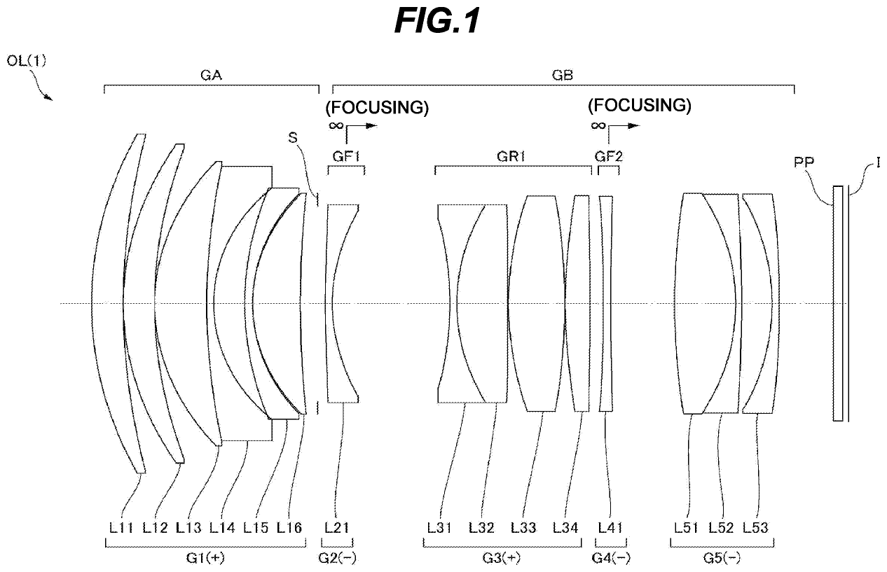

Next, an optical system according to the present embodiment is described. As shown in FIG. 1, an optical system OL(1) that is an example of an optical system (photographing lens) OL according to the present embodiment consists of, in order from an object on an optical axis: a front group GA; a stop (aperture stop) S; and a rear group GB. The rear group GB comprises a focusing lens group (GF1) that is disposed closest to the object in the rear group GB, and has a negative refractive power. Upon focusing, the focusing lens group moves on the optical axis, and distances between lens groups adjacent to each other change.

As to the configuration described above, the optical system OL according to the present embodiment satisfies the following conditional expression (1):

0.50<ST/TL<0.95 (1)

where ST: a distance from the aperture stop S to an image surface I on the optical axis, and

TL: an entire length of the optical system OL.

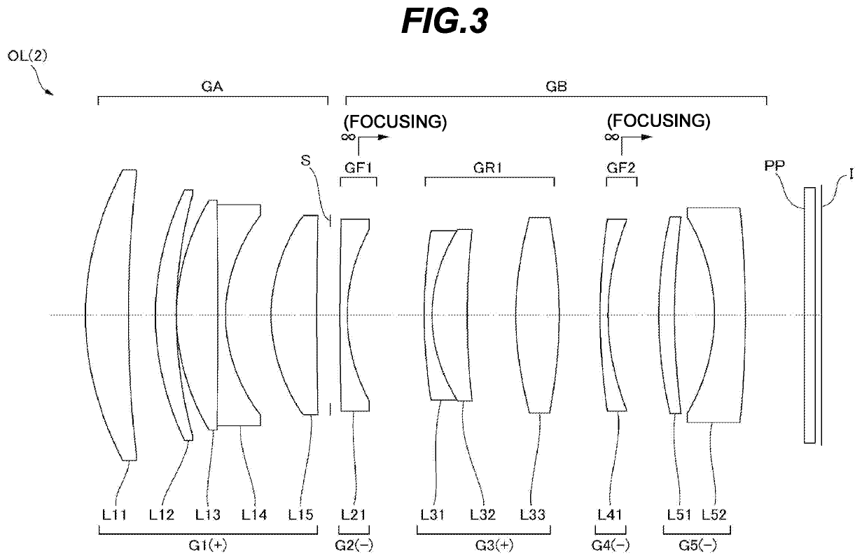

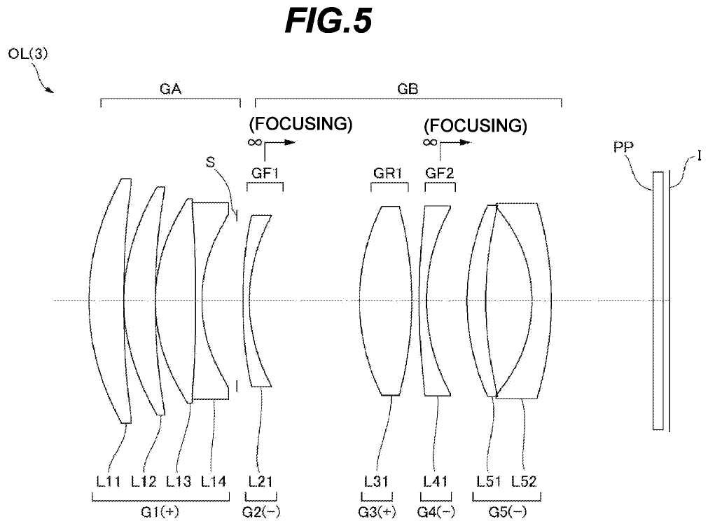

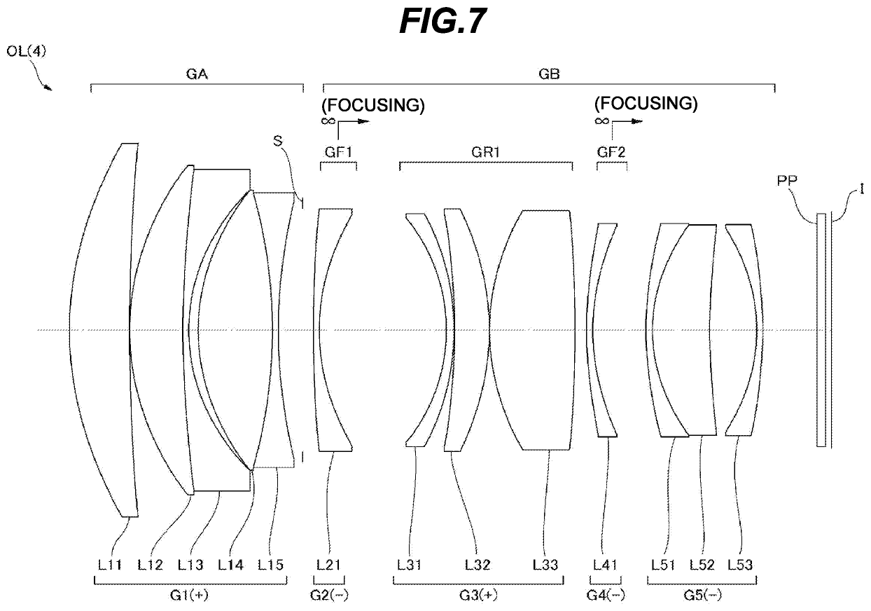

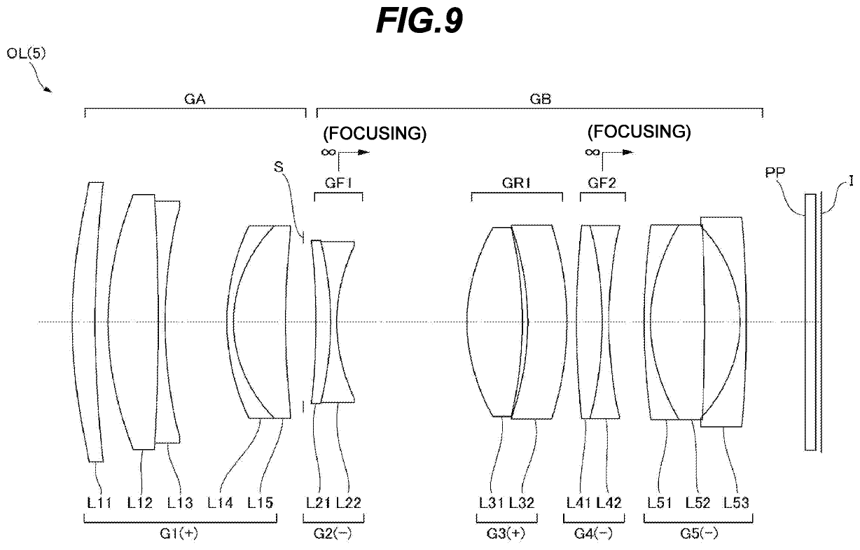

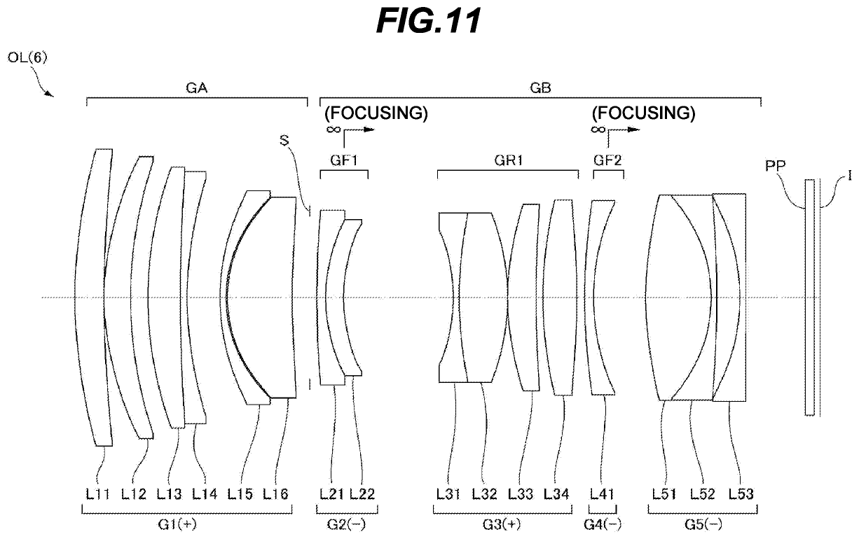

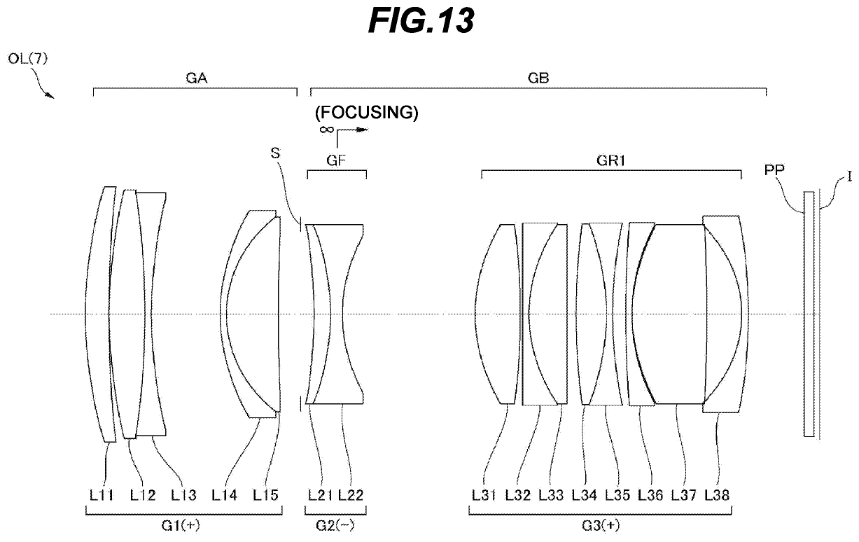

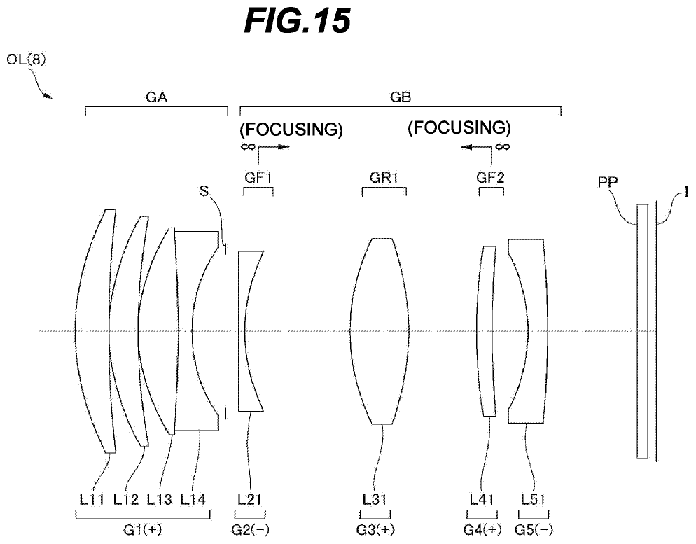

The present embodiment can achieve the optical system that has small fluctuation in angle of view upon focusing, and the optical apparatus that comprises the optical system. The optical system OL according to the present embodiment may be the optical system OL(2) shown in FIG. 3, the optical system OL(3) shown in FIG. 5, the optical system OL(4) shown in FIG. 7, or the optical system OL(5) shown in FIG. 9. The optical system OL according to the present embodiment may be the optical system OL(6) shown in FIG. 11, the optical system OL(7) shown in FIG. 13, or the optical system OL(8) shown in FIG. 15.

The conditional expression (1) defines an appropriate relationship between the distance from the aperture stop S to the image surface I on the optical axis and the entire length of the optical system OL. By satisfying the conditional expression (1), the fluctuation in angle of view upon focusing can be reduced.

If the corresponding value of the conditional expression (1) falls outside of the range, it is difficult to suppress the fluctuation in angle of view upon focusing. By setting the lower limit value of the conditional expression (1) to 0.53, 0.55, 0.58, 0.60, 0.63, or further to 0.65, the advantageous effects of the present embodiment can be more secured. By setting the upper limit value of the conditional expression (1) to 0.93, 0.90, 0.88, 0.85, 0.83, 0.80, or further to 0.78, the advantageous effects of the present embodiment can be more secured.

Preferably, the optical system OL according to the present embodiment satisfies the following conditional expression (2):

0.65<(−fF)/fA<1.20 (2)

where fF: a focal length of the focusing lens group, and

fA: a focal length of the front group GA.

The conditional expression (2) defines an appropriate relationship between the focal length of the focusing lens group and the focal length of the front group GA. By satisfying the conditional expression (2), the fluctuation in angle of view upon focusing can be reduced.

If the corresponding value of the conditional expression (2) falls outside of the range, it is difficult to suppress the fluctuation in angle of view upon focusing. By setting the lower limit value of the conditional expression (2) to 0.68, 0.70, 0.73, 0.75, or further to 0.77, the advantageous effects of the present embodiment can be more secured. By setting the upper limit value of the conditional expression (2) to 1.18, 1.15, 1.13, 1.00, or further to 1.09, the advantageous effects of the present embodiment can be more secured.

Preferably, in the optical system OL according to the present embodiment, the rear group GB comprises at least one lens group disposed closer to the image surface than the focusing lens group, and the following conditional expression (3) is satisfied,

0.70<(−fF)/fR<1.80 (3)

where fF: a focal length of the focusing lens group, and

fR: a combined focal length of the at least one lens group.

The conditional expression (3) defines an appropriate relationship between the focal length of the focusing lens group and the combined focal length of at least one lens group disposed closer to the image surface than the focusing lens group. Note that the combined focal length of the at least one lens group is the combined focal length upon focusing on the infinity object. In a case where the number of lens groups is one, the combined focal length of the at least one lens group is the focal length of the one lens group. In a case where the number of lens groups is two or more, the combined focal length of the at least one lens group is the combined focal length of the two or more lens groups. By satisfying the conditional expression (3), the fluctuation in angle of view upon focusing can be reduced.

If the corresponding value of the conditional expression (3) falls outside of the range, it is difficult to suppress the fluctuation in angle of view upon focusing. By setting the lower limit value of the conditional expression (3) to 0.73, 0.75, 0.78, 0.80, or further to 0.83, the advantageous effects of the present embodiment can be more secured. By setting the upper limit value of the conditional expression (3) to 1.78, 1.75, 1.73, 1.70, 1.68, 1.65, or further to 1.63, the advantageous effects of the present embodiment can be more secured.

Preferably, in the optical system OL according to the present embodiment, the rear group GB comprises a succeeding lens group GR1 disposed adjacent on an image side of the focusing lens group, and the following conditional expression (4) is satisfied,

0.00<βR1/βF<0.25 (4)

where βR1: a lateral magnification of the succeeding lens group GR1 upon focusing on an infinity object, and

βF: a lateral magnification of the focusing lens group upon focusing on the infinity object.

The conditional expression (4) defines an appropriate relationship between the lateral magnification of the succeeding lens group GR1 upon focusing on the infinity object and the lateral magnification of the focusing lens group upon focusing on the infinity object. By satisfying the conditional expression (4), the fluctuation in image magnification upon focusing can be reduced.

If the corresponding value of the conditional expression (4) falls outside of the range, it is difficult to suppress the fluctuation in image magnification upon focusing. By setting the lower limit value of the conditional expression (4) to 0.01, the advantageous effects of the present embodiment can be more secured. By setting the upper limit value of the conditional expression (4) to 0.23, 0.20, 0.18, 0.16, or further to 0.15, the advantageous effects of the present embodiment can be more secured.

Preferably, the optical system OL according to the present embodiment satisfies the following conditional expression (5):

0.03<Δx/f<0.35 (5)

where Δx: an amount of movement of the focusing lens group upon focusing from an infinity object to a short distance object, and

f: a focal length of the optical system OL.

The conditional expression (5) defines an appropriate relationship between the amount of movement of the focusing lens group upon focusing and the focal length of the optical system OL. By satisfying the conditional expression (5), the curvature of field, the spherical aberration, the coma aberration and the like can be favorably corrected. In the present embodiment, the sign of the amount of movement of the focusing lens group toward the image surface is +, and the sign of the amount of movement toward the object is −.

If the corresponding value of the conditional expression (5) falls outside of the range, it is difficult to correct the curvature of field, the spherical aberration, the coma aberration and the like. By setting the lower limit value of the conditional expression (5) to 0.04, 0.06, or further to 0.08, the advantageous effects of the present embodiment can be more secured. By setting the upper limit value of the conditional expression (5) to 0.33, 0.30, 0.28, 0.25, 0.23, 0.20, further to 0.18, the advantageous effects of the present embodiment can be more secured.

Preferably, the optical system OL according to the present embodiment satisfies the following conditional expression (6):

0.65<f/(−fF)<1.60 (6)

where f: a focal length of the optical system OL, and

fF: a focal length of the focusing lens group.

The conditional expression (6) defines an appropriate relationship between the focal length of the optical system OL and the focal length of the focusing lens group. By satisfying the conditional expression (6), the chromatic aberrations, the curvature of field and the like can be favorably corrected.

If the corresponding value of the conditional expression (6) falls outside of the range, it is difficult to correct the chromatic aberrations, the curvature of field and the like. By setting the lower limit value of the conditional expression (6) to 0.68, 0.70, or further to 0.73, the advantageous effects of the present embodiment can be more secured. By setting the upper limit value of the conditional expression (6) to 1.58, 1.55, 1.53, 1.50, 1.48, 1.45, 1.43, or further to 1.40, the advantageous effects of the present embodiment can be more secured.

Preferably, the optical system OL according to the present embodiment satisfies the following conditional expression (7):

2.00<TL/(FNO×Bf)<10.00 (7)

where FNO: an f-number of the optical system OL, and

Bf: a back focus of the optical system OL.

The conditional expression (7) defines an appropriate relationship between the entire length of the optical system OL, and the f-number and the back focus of the optical system OL. By satisfying the conditional expression (7), even the peripheral illumination can be sufficiently secured, and the optical system that has a large aperture and a short back focus can be achieved. Note that the back focus of the optical system OL in the conditional expression (7) and the after-mentioned conditional expression (14) indicates the distance (air equivalent distance) on the optical axis, to the image surface I, from the image-side lens surface of the lens of the optical system OL disposed closest to the image surface.

If the corresponding value of the conditional expression (7) falls outside of the range, it is difficult to sufficiently secure sufficient illumination around the angle of view. By setting the lower limit value of the conditional expression (7) to 2.10, 2.15, 2.20, 2.25, 2.30, 2.35, 2.40, further to 2.43, the advantageous effects of the present embodiment can be more secured. By setting the upper limit value of the conditional expression (7) to 9.85, 9.65, 9.60, 9.55, 9.50, 9.45, or further to 9.40, the advantageous effects of the present embodiment can be more secured.

Preferably, in the optical system OL according to the present embodiment, the focusing lens group consists of one negative lens component. Since the focusing lens group thus decreases in weight, focusing from the infinity object to the short distance object can be performed at high speed. Note that in the present embodiment, the lens component indicates a single lens or a cemented lens.

Preferably, the optical system OL according to the present embodiment satisfies the following conditional expression (8):

−2.50<(rFR2+rFR1)/(rFR2−rFR1)<−0.25 (8)

where rFR1: a radius of curvature of a lens surface closest to the object in the focusing lens group, and

rFR2: a radius of curvature of a lens surface closest to the image surface in the focusing lens group.

The conditional expression (8) defines an appropriate range of the shape factor of the lenses constituting the focusing lens group. By satisfying the conditional expression (8), the spherical aberration, the coma aberration and the like can be favorably corrected.

If the corresponding value of the conditional expression (8) falls outside of the range, it is difficult to correct the spherical aberration, the coma aberration and the like. By setting the lower limit value of the conditional expression (8) to −2.45, −2.40, −2.35, −2.30, −2.25, or further to −2.23, the advantageous effects of the present embodiment can be more secured. By setting the upper limit value of the conditional expression (8) to −0.30, −0.33, −0.35, −0.38, −0.40, −0.43, −0.45, −0.48, or further to −0.50, the advantageous effects of the present embodiment can be more secured.

Preferably, the optical system OL according to the present embodiment satisfies the following conditional expression (9):

0.90<(rNR2+rNR1)/(rNR2−rNR1)<2.65 (9)

where rNR1: a radius of curvature of an object-side lens surface of a lens of the optical system OL that is disposed closest to the image surface, and

rNR2: a radius of curvature of an image-side lens surface of a lens of the optical system OL that is disposed closest to the image surface.

The conditional expression (9) defines an appropriate range of the shape factor of the lens of the optical system OL that is disposed closest to the image surface. By satisfying the conditional expression (9), the spherical aberration, the distortion and the like can be favorably corrected.

If the corresponding value of the conditional expression (9) falls outside of the range, it is difficult to correct the spherical aberration, and the distortion. By setting the lower limit value of the conditional expression (9) to 0.93, 0.95, 0.98, 1.00, or further to 1.02, the advantageous effects of the present embodiment can be more secured. By setting the upper limit value of the conditional expression (9) to 2.60, 2.58, 2.55, 2.53, 2.50, 2.48, or further to 2.45, the advantageous effects of the present embodiment can be more secured.

Preferably, the optical system OL according to the present embodiment satisfies the following conditional expression (10):

0.08<1/βF<0.55 (10)

where βF: a lateral magnification of the focusing lens group upon focusing on the infinity object.

The conditional expression (10) defines an appropriate range of the lateral magnification of the focusing lens group upon focusing on the infinity object. By satisfying the conditional expression (10), the various aberrations, such as the spherical aberration and the curvature of field, upon focusing on the infinity object can be favorably corrected.

If the corresponding value of the conditional expression (10) falls outside of the range, it is difficult to correct various aberrations, such as the spherical aberration and the curvature of field upon focusing on the infinity object. By setting the lower limit value of the conditional expression (10) to 0.10, 0.12, or further to 0.14, the advantageous effects of the present embodiment can be more secured. By setting the upper limit value of the conditional expression (10) to 0.53, 0.50, 0.48, 0.45, or further to 0.43, the advantageous effects of the present embodiment can be more secured.

Preferably, the optical system OL according to the present embodiment satisfies the following conditional expression (11):

{βF+(1/βF)}⁻²<0.15 (11)

where βF: a lateral magnification of the focusing lens group upon focusing on the infinity object.

The conditional expression (11) defines an appropriate range of the lateral magnification of the focusing lens group upon focusing on the infinity object. By satisfying the conditional expression (11), the various aberrations, such as the spherical aberration and the curvature of field, upon focusing on the infinity object can be favorably corrected.

If the corresponding value of the conditional expression (11) falls outside of the range, it is difficult to correct various aberrations, such as the spherical aberration and the curvature of field upon focusing on the infinity object. By setting the upper limit value of the conditional expression (11) to 0.14, or further to 0.13, the advantageous effects of the present embodiment can be more secured.

Preferably, the optical system OL according to the present embodiment satisfies the following conditional expression (12):

0.003<BLDF/TL<0.060 (12)

where BLDF: a length of the focusing lens group on the optical axis.

The conditional expression (12) defines an appropriate relationship between the length of the focusing lens group on the optical axis and the entire length of the optical system OL. By satisfying the conditional expression (12), the focusing lens group can be reduced in weight, and the fluctuation in the various aberrations upon focusing can be suppressed.

If the corresponding value of the conditional expression (12) falls outside of the range, it is difficult to correct the fluctuation in various aberrations upon focusing. By setting the lower limit value of the conditional expression (12) to 0.004, 0.006, or further to 0.008, the advantageous effects of the present embodiment can be more secured. By setting the upper limit value of the conditional expression (12) to 0.058, 0.055, 0.053, 0.050, 0.048, 0.045, or further to 0.043, the advantageous effects of the present embodiment can be more secured.

Preferably, the optical system OL according to the present embodiment satisfies the following conditional expression (13):

0.05<βB/βF<0.50 (13)

where βB: a lateral magnification of the rear group GB upon focusing on an infinity object, and

βF: a lateral magnification of the focusing lens group upon focusing on the infinity object.

The conditional expression (13) defines an appropriate relationship between the lateral magnification of the rear group GB upon focusing on the infinity object and the lateral magnification of the focusing lens group upon focusing on the infinity object. By satisfying the conditional expression (13), the fluctuation in angle of view upon focusing on the infinity object can be suppressed.

If the corresponding value of the conditional expression (13) falls outside of the range, it is difficult to suppress the fluctuation in angle of view upon focusing on the infinity object. By setting the lower limit value of the conditional expression (13) to 0.06, 0.08, 0.10, or further to 0.12, the advantageous effects of the present embodiment can be more secured. By setting the upper limit value of the conditional expression (13) to 0.48, 0.45, 0.43, 0.40, or further to 0.38, the advantageous effects of the present embodiment can be more secured.

Preferably, the optical system OL according to the present embodiment satisfies the following conditional expression (14):

0.05<Bf/TL<0.25 (14)

where Bf: a back focus of the optical system OL.

The conditional expression (14) defines an appropriate relationship between the back focus of the optical system OL and the entire length of the optical system OL. By satisfying the conditional expression (14), the back focus can be reduced with respect to the entire length of the optical system, and the optical system can be reduced in size. Accordingly, it is preferable.

If the corresponding value of the conditional expression (14) falls outside of the range, the back focus becomes long with respect to the entire length of the optical system, and it is difficult to reduce the size of the optical system accordingly. By setting the lower limit value of the conditional expression (14) to 0.06, or further to 0.08, the advantageous effects of the present embodiment can be more secured. By setting the upper limit value of the conditional expression (14) to 0.24, or further to 0.22, the advantageous effects of the present embodiment can be more secured.

Preferably, the optical system OL according to the present embodiment satisfies the following conditional expression (15):

1.00<FNO<3.00 (15)

where FNO: an f-number of the optical system OL.

The conditional expression (15) defines an appropriate range of the f-number of the optical system OL. By satisfying the conditional expression (15), the fast optical system can be achieved. Accordingly, it is preferable. By setting the lower limit value of the conditional expression (15) to 1.10, 1.15, or further to 1.20, the advantageous effects of the present embodiment can be more secured. By setting the upper limit value of the conditional expression (15) to 2.85, 2.70, 2.60, 2.50, 2.40, 2.30, 2.20, or further to 2.10, the advantageous effects of the present embodiment can be more secured.

Preferably, the optical system OL according to the present embodiment satisfies the following conditional expression (16):

12.00°<2ω<40.00° (16)

where 2ω: a full angle of view of the optical system OL.

The conditional expression (16) defines an appropriate range of the full angle of view of the optical system OL. By satisfying the conditional expression (16), the optical system having a wide angle of view can be achieve. Accordingly, it is preferable. By setting the lower limit value of the conditional expression (16) to 12.50°, 13.00°, 13.50°, 14.00°, or further to 14.50°, the advantageous effects of the present embodiment can be more secured. By setting the upper limit value of the conditional expression (16) to 38.50°, 37.00°, 36.00°, or further to 35.50°, the advantageous effects of the present embodiment can be more secured.

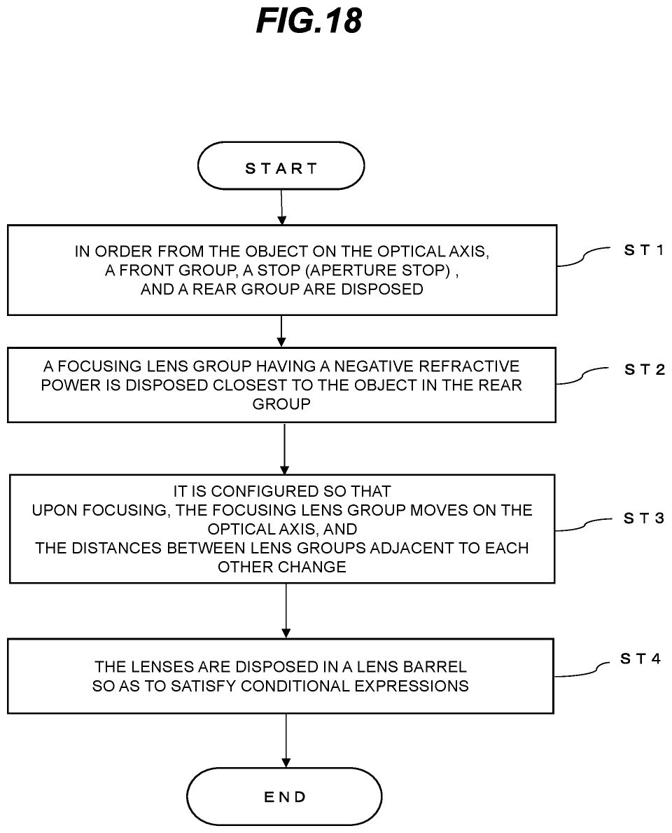

Subsequently, referring to FIG. 18, a method for manufacturing the optical system OL according to the present embodiment is schematically described. First, in order from the object on the optical axis, a front group GA, a stop (aperture stop) S, and a rear group GB are disposed (step ST1). Next, a focusing lens group (GF1) having a negative refractive power is disposed closest to the object in the rear group GB (step ST2). Next, it is configured so that upon focusing, the focusing lens group moves on the optical axis, and the distances between lens groups adjacent to each other change (step ST3). The lenses are disposed in a lens barrel so as to satisfy at least the conditional expression (1) (step ST4). According to such a manufacturing method, the optical system having small fluctuation in angle of view upon focusing can be manufactured.

### EXAMPLES

Hereinafter, optical systems OL according to Examples of the present embodiment are described with reference to the drawings. FIGS. 1, 3, 5, 7, 9, 11, 13 and 15 are sectional views showing the configurations and refractive power allocations of the optical systems OL {OL(1) to OL(8)} according to First to Eighth Examples. In the sectional views of the optical systems OL(1) to OL(8) according to First to Eighth Examples, the moving directions of the focusing lens groups on the optical axis upon focusing from infinity to the short distance object are indicated by arrows accompanied by characters of “FOCUSING”.

In FIGS. 1, 3, 5, 7, 9, 11, 13 and 15, each lens group is represented by a combination of a symbol G and a numeral, and each lens is represented by a combination of a symbol L and a numeral. In this case, to prevent complication due to increase in the types and numbers of symbols and numerals, the lens groups and the like are represented using the combinations of symbols and numerals independently for each Example. Accordingly, even when the same combination of a symbol and a numeral is used among Examples, such usage does not necessarily mean the same configuration.

Hereinafter, Tables 1 to 8 are shown. Among these tables, Table 1 is a table showing each data item in First Example, Table 2 is that in Second Example, Table 3 is that in Third Example, Table 4 is that in Fourth Example, Table 5 is that in Fifth Example, Table 6 is that in Sixth Example, Table 7 is that in Seventh Example, and Table 8 is that in Eighth Example. In each Example, for calculation of aberration characteristics, d-line (wavelength λ=587.6 nm), and g-line (wavelength λ=435.8 nm) are selected.

In the table of [General Data], f indicates the focal length of the entire lens system, FNO indicates the f-number, 2ω indicates the angle of view (the unit is ° (degree), and ω indicates the half angle of view), and Y indicates the image height. TL indicates a distance obtained by adding Bf to the distance from the lens foremost surface to the lens last surface on the optical axis upon focusing on infinity. Bf indicates the distance (back focus) from the lens last surface to the image surface I on the optical axis upon focusing on infinity. Bf(a) indicates the distance (air equivalent distance), to the image surface I, from the image-side lens surface of the lens of the optical system disposed closest to the image surface. In the table of [General Data], fA indicates the focal length of the front group. fR indicates the combined focal length of at least one lens group disposed closer to the image surface than the focusing lens group closest to the object in the rear group. Ax indicates the amount of movement of the focusing lens group upon focusing from the infinity object to the short distance object. βF indicates the lateral magnification of the focusing lens group upon focusing on the infinity object. βB indicates the lateral magnification of the rear group upon focusing on the infinity object. βR1 indicates the lateral magnification of the succeeding lens group upon focusing on the infinity object.

In the table of [Lens Data], Surface Number indicates the order of the optical surface from the object side along the direction in which the ray travels, R indicates the radius of curvature (the surface whose center of curvature resides on the image side is regarded to have a positive value) of each optical surface, D indicates the surface distance that is the distance on the optical axis from each optical surface to the next optical surface (or the image surface), nd is the refractive index of the material of the optical member for d-line, and vd indicates the Abbe number of the material of the optical member with reference to d-line. The radius of curvature “∞” indicates a plane or an opening. (Stop S) indicates an aperture stop S. The description of the air refractive index nd=1.00000 is omitted.

The table of [Variable Distance Data] shows the surface distance at each surface number i where the surface distance is (Di) in the table of [Lens Data]. Note that D0 indicates the distance from the object to the optical surface closest to the object in the optical system. In the table of [Variable Distance Data], f indicates the focal length of the entire lens system, and β indicates the photographing magnification.

The table of [Lens Group Data] shows the first surface (the surface closest to the object) and the focal length of each lens group.

Hereinafter, at all the data values, the listed focal length f, radius of curvature R, surface distance D, other lengths and the like are generally represented in “mm” if not otherwise specified. However, even after subjected to proportional scaling in or out, the optical system can achieve equivalent optical performances. Accordingly, the representation is not limited to this example.

The descriptions of the tables so far are common to all Examples. Redundant descriptions are hereinafter omitted.

### First Example

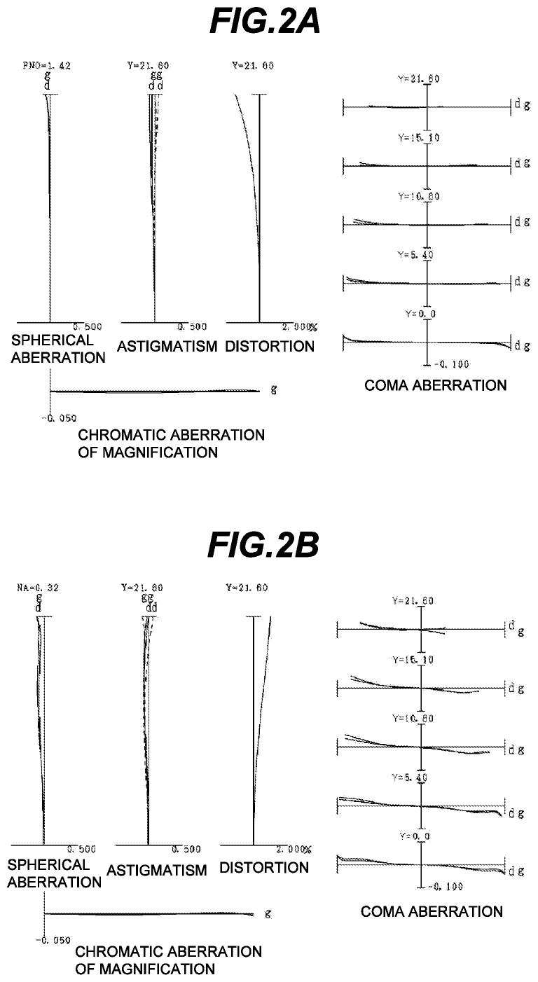

First Example is described with reference to FIGS. 1 and 2A and 2B and Table 1. FIG. 1 shows a lens configuration of an optical system according to First Example. The optical system OL(1) according to First Example consists of, in order from an object on the optical axis: a first lens group G1 having a positive refractive power; a second lens group G2 having a negative refractive power; a third lens group G3 having a positive refractive power; a fourth lens group G4 having a negative refractive power; and a fifth lens group G5 having a negative refractive power. Upon focusing from the infinity object to the short distance object, the second lens group G2 and the fourth lens group G4 move toward the image on the optical axis, and the distances between the lens groups adjacent to each other change. Note that upon focusing, the first lens group G1, the third lens group G3 and the fifth lens group G5 are fixed with respect to the image surface I. The sign (+) or (−) assigned to each lens group symbol indicates the refractive power of the corresponding lens group. This indication similarly applies to all the following Examples.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a positive meniscus lens L12 having a convex surface facing the object; a cemented lens including a positive meniscus lens L13 having a convex surface facing the object, and a negative meniscus lens L14 having a convex surface facing the object; a negative meniscus lens L15 having a convex surface facing the object; and a positive meniscus lens L16 having a convex surface facing the object. The second lens group G2 consists of a negative meniscus lens L21 having a convex surface facing the object.

The third lens group G3 consists of, in order from the object on the optical axis: a cemented lens including a biconcave negative lens L31, and a biconvex positive lens L32; a biconvex positive lens L33; and a biconvex positive lens L34. The fourth lens group G4 consists of a biconcave negative lens L41.

The fifth lens group G5 consists of, in order from the object on the optical axis: a cemented lens including a biconvex positive lens L51, and a negative meniscus lens L52 having a concave surface facing the object; and a negative meniscus lens L53 having a concave surface facing the object. An image surface I is disposed on the image side of the fifth lens group G5. A parallel plate PP is disposed between the fifth lens group G5 and the image surface I.

The following Table 1 lists values of data on the optical system according to First Example.

TABLE 1
[General Data]

| | |
|---|---|
| f = 87.000 | fA = 89.351 |
| FNO = 1.424 | fR = 64.417 |
| 2ω = 28.285 | Δx = 12.719 |
| Y = 21.600 | βF = 2.601 |
| TL = 129.013 | βB = 0.974 |
| Bf = 1.000 | βR1 = 0.359 |
| Bf (a) = 11.168 | |

[Lens Data]

| Surface | | | | | |
|---|---|---|---|---|---|
| Number | R | D | nd | νd | |
| 1 | 69.6342 | 5.430 | 1.9591 | 17.47 | |
| 2 | 132.1539 | 0.116 | | | |
| 3 | 55.3642 | 5.244 | 2.0010 | 29.13 | |
| 4 | 89.6665 | 0.100 | | | |
| 5 | 40.4445 | 8.778 | 1.5503 | 75.49 | |
| 6 | 140.0000 | 1.200 | 1.8548 | 24.80 | |
| 7 | 29.5861 | 5.360 | | | |
| 8 | 63.3783 | 1.200 | 1.9229 | 20.88 | |
| 9 | 31.8132 | 0.100 | | | |
| 10 | 31.2943 | 8.078 | 1.7292 | 54.67 | |
| 11 | 237.3897 | 2.787 | | | |
| 12 | ∞ | (D12) | | | (Aperture |
| | | | | | Stop S) |
| 13 | 438.3400 | 1.200 | 1.5163 | 64.14 | |
| 14 | 38.4472 | (D14) | | | |
| 15 | −65.9934 | 1.200 | 1.7783 | 23.91 | |
| 16 | 39.9168 | 8.673 | 1.8040 | 46.53 | |
| 17 | −723.3882 | 0.100 | | | |
| 18 | 70.0000 | 9.587 | 1.8160 | 46.62 | |
| 19 | −124.9732 | 0.100 | | | |
| 20 | 135.5192 | 4.257 | 1.9591 | 17.47 | |
| 21 | −631.3761 | (D21) | | | |
| 22 | −255.5306 | 1.200 | 1.6989 | 30.13 | |
| 23 | 1196.1373 | (D23) | | | |
| 24 | 148.6618 | 10.553 | 1.9591 | 17.47 | |
| 25 | −40.7482 | 1.000 | 1.8929 | 20.36 | |
| 26 | −348.6817 | 5.247 | | | |
| 27 | −43.6865 | 1.200 | 1.7783 | 23.91 | |
| 28 | −175.9036 | 9.113 | | | |
| 29 | ∞ | 1.600 | 1.5168 | 63.88 | |
| 30 | ∞ | Bf | | | |

[Variable Distance Data]

| | | Upon focusing | Upon focusing |
|---|---|---|---|
| | Upon focusing | on an intermediate | on a very short |
| | on infinity | distance object | distance object |
| | f = 87.000 | β = −0.034 | β = −0.126 |
| D0 | ∞ | 2570.805 | 728.956 |
| D12 | 1.500 | 4.805 | 14.219 |
| D14 | 19.979 | 16.674 | 7.260 |
| D21 | 2.293 | 4.042 | 10.530 |
| D23 | 10.820 | 9.071 | 2.583 |

[Lens Group Data]

| | First | Focal |
|---|---|---|
| Group | surface | length |
| G1 | 1 | 89.351 |
| G2 | 13 | −81.705 |
| G3 | 15 | 54.836 |
| G4 | 22 | −301.138 |
| G5 | 24 | −611.471 |

FIG. 2A shows graphs of various aberrations of the optical system upon focusing on infinity according to First Example. FIG. 2B shows graphs of various aberrations of the optical system upon focusing on the short distance object according to First Example. In each aberration graph upon focusing on infinity, FNO indicates the f-number, and Y indicates the image height. In each aberration graph upon focusing on the short distance object, NA indicates the numerical aperture, and Y indicates the image height. Note that the spherical aberration graph indicates the value of the f-number or the numerical aperture that corresponds to the maximum aperture. The astigmatism graph and the distortion graph each indicate the maximum value of the image height. The coma aberration graph indicates the value of the corresponding image height. The symbol d indicates d-line (wavelength λ=587.6 nm). The symbol g indicates g-line (wavelength λ=435.8 nm). In the astigmatism graph, a solid line indicates a sagittal image surface, and a broken line indicates a meridional image surface. Note that also in the aberration graphs in the following Examples, symbols similar to those in this Example are used, and redundant description is omitted.

The various aberration graphs show that in the optical system according to First Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Second Example

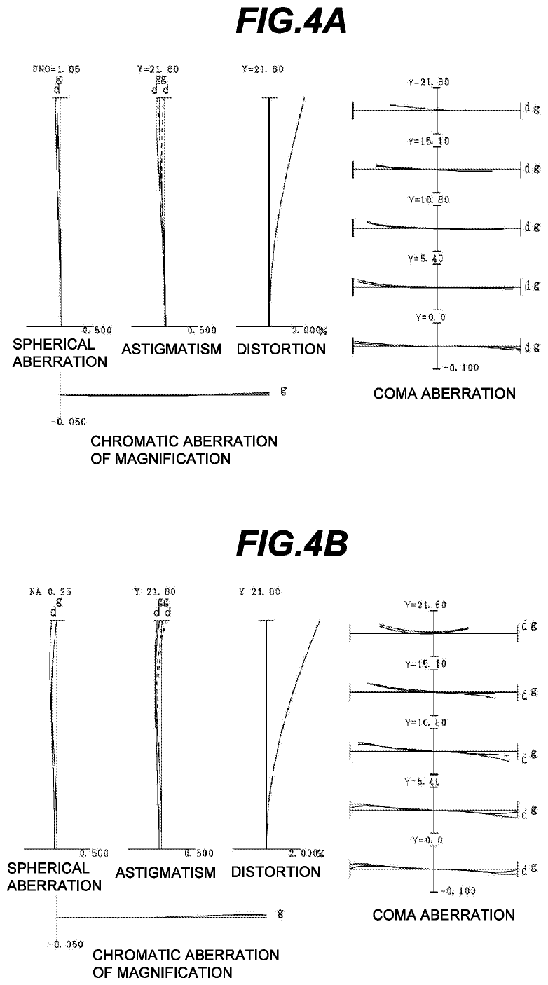

Second Example is described with reference to FIGS. 3 and 4A and 4B and Table 2. FIG. 3 shows a lens configuration of an optical system according to Second Example. The optical system OL(2) according to Second Example consists of, in order from an object on the optical axis: a first lens group G1 having a positive refractive power; a second lens group G2 having a negative refractive power; a third lens group G3 having a positive refractive power; a fourth lens group G4 having a negative refractive power; and a fifth lens group G5 having a negative refractive power. Upon focusing from the infinity object to the short distance object, the second lens group G2 and the fourth lens group G4 move toward the image on the optical axis, and the distances between the lens groups adjacent to each other change. Note that upon focusing, the first lens group G1, the third lens group G3 and the fifth lens group G5 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a positive meniscus lens L12 having a convex surface facing the object; a cemented lens including a biconvex positive lens L13, and a biconcave negative lens L14; and a positive meniscus lens L15 having a convex surface facing the object. The second lens group G2 consists of a negative meniscus lens L21 having a convex surface facing the object.

The third lens group G3 consists of, in order from the object on the optical axis: a cemented lens including a negative meniscus lens L31 having a convex surface facing the object, and a positive meniscus lens L32 having a convex surface facing the object; and a biconvex positive lens L33. The fourth lens group G4 consists of a negative meniscus lens L41 having a convex surface facing the object.

The fifth lens group G5 consists of, in order from the object on the optical axis: a positive meniscus lens L51 having a convex surface facing the object; and a negative meniscus lens L52 having a concave surface facing the object. An image surface I is disposed on the image side of the fifth lens group G5. A parallel plate PP is disposed between the fifth lens group G5 and the image surface I.

The following Table 2 lists values of data on the optical system according to Second Example.

TABLE 2
[General Data]

| | |
|---|---|
| f = 84.853 | fA = 83.808 |
| FNO = 1.855 | fR = 70.031 |
| 2ω = 28.002 | Δx = 8.031 |
| Y = 21.600 | βF = 4.398 |
| TL = 114.050 | βB = 1.012 |
| Bf = 1.000 | βR1 = 0.165 |
| Bf (a) = 11.205 | |

[Lens Data]

| Surface | | | | | |
|---|---|---|---|---|---|
| Number | R | D | nd | νd | |
| 1 | 57.5903 | 6.716 | 1.8081 | 22.76 | |
| 2 | 250.0000 | 4.134 | | | |
| 3 | 54.4191 | 3.242 | 1.7725 | 49.60 | |
| 4 | 87.8376 | 0.100 | | | |
| 5 | 42.6165 | 6.392 | 1.4560 | 91.37 | |
| 6 | −1029.0613 | 1.200 | 2.0007 | 25.46 | |
| 7 | 30.7264 | 7.020 | | | |
| 8 | 33.1538 | 7.106 | 1.4978 | 82.57 | |
| 9 | 2847.8763 | 2.046 | | | |
| 10 | ∞ | (D10) | | | (Aperture |
| | | | | | Stop S) |
| 11 | 1361.3846 | 1.200 | 1.5530 | 55.07 | |
| 12 | 35.8243 | (D12) | | | |
| 13 | 105.7816 | 1.200 | 1.8052 | 25.46 | |
| 14 | 30.0129 | 5.549 | 1.7292 | 54.67 | |
| 15 | 177.6261 | 7.465 | | | |
| 16 | 70.0000 | 6.745 | 2.0007 | 25.46 | |
| 17 | −91.9564 | (D17) | | | |
| 18 | 135.9285 | 1.200 | 1.6730 | 38.26 | |
| 19 | 50.2105 | (D19) | | | |
| 20 | 85.3901 | 2.439 | 2.0010 | 29.13 | |
| 21 | 157.8735 | 6.189 | | | |
| 22 | −36.1082 | 4.843 | 1.8081 | 22.76 | |
| 23 | −200.0000 | 9.150 | | | |
| 24 | ∞ | 1.600 | 1.5168 | 63.88 | |
| 25 | ∞ | Bf | | | |

[Variable Distance Data]

| | | Upon focusing | Upon focusing |
|---|---|---|---|
| | Upon focusing | on an intermediate | on a very short |
| | on infinity | distance object | distance object |
| | f = 84.853 | β = −0.034 | β = −0.120 |
| D0 | ∞ | 2544.448 | 725.082 |
| D10 | 1.500 | 3.593 | 9.531 |
| D12 | 11.802 | 9.709 | 3.771 |
| D17 | 6.374 | 7.694 | 11.374 |
| D19 | 7.839 | 6.518 | 2.839 |

[Lens Group Data]

| | First | Focal |
|---|---|---|
| Group | surface | length |
| G1 | 1 | 83.808 |
| G2 | 11 | −66.556 |
| G3 | 13 | 40.059 |
| G4 | 18 | −118.979 |
| G5 | 20 | −84.660 |

FIG. 4A shows graphs of various aberrations of the optical system upon focusing on infinity according to Second Example. FIG. 4B shows graphs of various aberrations of the optical system upon focusing on the short distance object according to Second Example. The various aberration graphs show that in the optical system according to Second Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Third Example

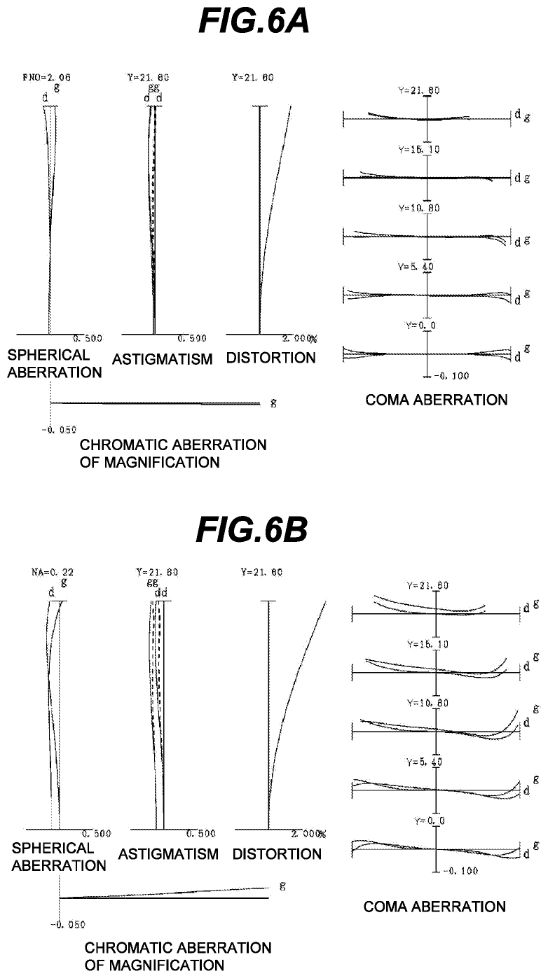

Third Example is described with reference to FIGS. 5 and 6A and 6B and Table 3. FIG. 5 shows a lens configuration of an optical system according to Third Example. The optical system OL(3) according to Third Example consists of, in order from an object on the optical axis: a first lens group G1 having a positive refractive power; a second lens group G2 having a negative refractive power; a third lens group G3 having a positive refractive power; a fourth lens group G4 having a negative refractive power; and a fifth lens group G5 having a negative refractive power. Upon focusing from the infinity object to the short distance object, the second lens group G2 and the fourth lens group G4 move toward the image on the optical axis, and the distances between the lens groups adjacent to each other change. Note that upon focusing, the first lens group G1, the third lens group G3 and the fifth lens group G5 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a positive meniscus lens L12 having a convex surface facing the object; and a cemented lens including a biconvex positive lens L13, and a biconcave negative lens L14. The second lens group G2 consists of a negative meniscus lens L21 having a convex surface facing the object.

The third lens group G3 consists of a biconvex positive lens L31. The fourth lens group G4 consists of a negative meniscus lens L41 having a convex surface facing the object.

The fifth lens group G5 consists of, in order from the object on the optical axis: a positive meniscus lens L51 having a convex surface facing the object; and a negative meniscus lens L52 having a concave surface facing the object. An image surface I is disposed on the image side of the fifth lens group G5. A parallel plate PP is disposed between the fifth lens group G5 and the image surface I.

The following Table 3 lists values of data on the optical system according to Third Example.

TABLE 3
[General Data]

| | |
|---|---|
| f = 82.010 | fA = 102.479 |
| FNO = 2.060 | fR = 82.146 |
| 2ω = 28.969 | Δx = 10.381 |
| Y = 21.600 | βF = 2.495 |
| TL = 90.023 | βB = 0.800 |
| Bf = 1.000 | βR1 = 0.202 |
| Bf (a) = 17.858 | |

[Lens Data]

| Surface | | | | | |
|---|---|---|---|---|---|
| Number | R | D | nd | νd | |
| 1 | 46.5771 | 5.350 | 1.7725 | 49.60 | |
| 2 | 179.4303 | 0.100 | | | |
| 3 | 40.3285 | 4.836 | 1.4970 | 81.61 | |
| 4 | 129.0466 | 0.100 | | | |
| 5 | 33.5684 | 6.218 | 1.4560 | 91.37 | |
| 6 | −229.0734 | 1.000 | 1.9004 | 37.37 | |
| 7 | 29.9047 | 5.182 | | | |
| 8 | ∞ | (D8) | | | (Aperture |
| | | | | | Stop S) |
| 9 | 88.7347 | 1.000 | 1.4875 | 70.23 | |
| 10 | 33.2383 | (D10) | | | |
| 11 | 40.9864 | 8.072 | 1.7130 | 53.87 | |
| 12 | −66.9077 | (D12) | | | |
| 13 | 159.0319 | 1.157 | 1.5814 | 40.75 | |
| 14 | 37.2505 | (D14) | | | |
| 15 | 46.6687 | 2.874 | 1.8590 | 22.73 | |
| 16 | 78.4005 | 7.093 | | | |
| 17 | −26.5540 | 3.000 | 1.9037 | 31.31 | |
| 18 | −63.6154 | 15.803 | | | |
| 19 | ∞ | 1.600 | 1.5168 | 63.88 | |
| 20 | ∞ | Bf | | | |

[Variable Distance Data]

| | | Upon focusing | Upon focusing |
|---|---|---|---|
| | Upon focusing | on an intermediate | on a very short |
| | on infinity | distance object | distance object |
| | f = 82.010 | β = −0.032 | β = −0.113 |
| D0 | ∞ | 2519.887 | 756.709 |
| D8 | 1.066 | 3.911 | 11.447 |
| D10 | 17.056 | 14.211 | 6.675 |
| D12 | 1.148 | 2.146 | 4.829 |
| D14 | 6.369 | 5.372 | 2.688 |

[Lens Group Data]

| | First | Focal |
|---|---|---|
| Group | surface | length |
| G1 | 1 | 102.479 |
| G2 | 9 | −109.666 |
| G3 | 11 | 36.793 |
| G4 | 13 | −83.956 |
| G5 | 15 | −101.166 |

FIG. 6A shows graphs of various aberrations of the optical system upon focusing on infinity according to Third Example. FIG. 6B shows graphs of various aberrations of the optical system upon focusing on the short distance object according to Third Example. The various aberration graphs show that in the optical system according to Third Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Fourth Example

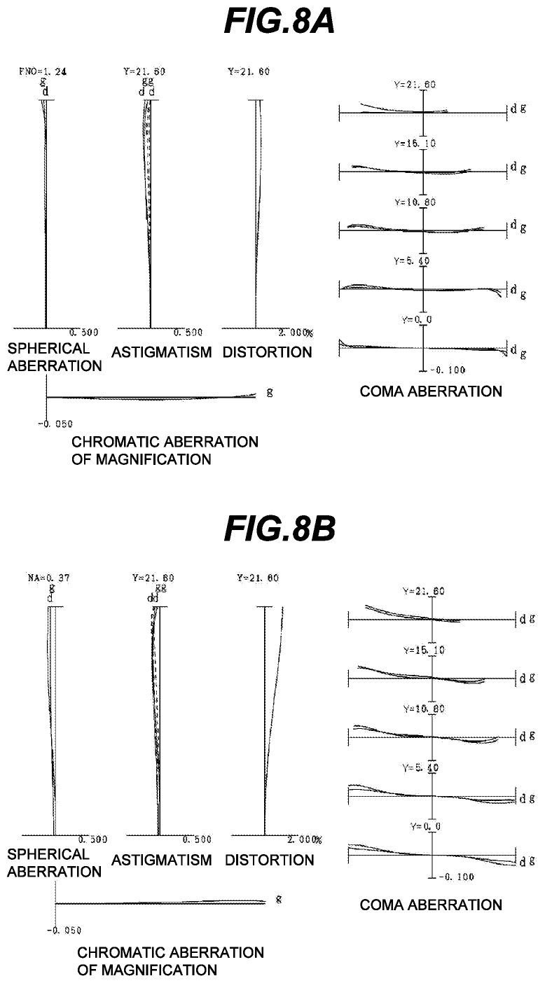

Fourth Example is described with reference to FIGS. 7 and FIGS. 8A and 8B and Table 4. FIG. 7 shows a lens configuration of an optical system according to Fourth Example. The optical system OL(4) according to Fourth Example consists of, in order from an object on the optical axis: a first lens group G1 having a positive refractive power; a second lens group G2 having a negative refractive power; a third lens group G3 having a positive refractive power; a fourth lens group G4 having a negative refractive power; and a fifth lens group G5 having a negative refractive power. Upon focusing from the infinity object to the short distance object, the second lens group G2 and the fourth lens group G4 move toward the image on the optical axis, and the distances between the lens groups change. Note that upon focusing, the first lens group G1, the third lens group G3 and the fifth lens group G5 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a cemented lens including a positive meniscus lens L12 having a convex surface facing the object, and a negative meniscus lens L13 having a convex surface facing the object; and a cemented lens including a biconvex positive lens L14, and a biconcave negative lens L15. The second lens group G2 consists of a negative meniscus lens L21 having a convex surface facing the object.

The third lens group G3 consists of, in order from the object on the optical axis: a negative meniscus lens L31 having a concave surface facing the object; a positive meniscus lens L32 having a concave surface facing the object; and a biconvex positive lens L33. The fourth lens group G4 consists of a negative meniscus lens L41 having a convex surface facing the object.

The fifth lens group G5 consists of, in order from the object on the optical axis: a negative meniscus lens L51 having a convex surface facing the object; a positive meniscus lens L52 having a convex surface facing the object; and a negative meniscus lens L53 having a concave surface facing the object. An image surface I is disposed on the image side of the fifth lens group G5. A parallel plate PP is disposed between the fifth lens group G5 and the image surface I.

The following Table 4 lists values of data on the optical system according to Fourth Example.

TABLE 4
[General Data]

| | |
|---|---|
| f = 84.453 | fA = 118.522 |
| FNO = 1.242 | fR = 61.307 |
| 2ω = 28.622 | Δx = 10.784 |
| Y = 21.600 | βF = 3.780 |
| TL = 130.011 | βB = 0.713 |
| Bf = 1.000 | βR1 = 0.153 |
| Bf (a) = 11.185 | |

| [Lens Data] | | | | | |
|---|---|---|---|---|---|
| Surface | | | | | |
| Number | R | D | nd | νd | |
| 1 | 73.2143 | 10.224 | 1.8929 | 20.36 | |
| 2 | 453.0360 | 0.100 | | | |
| 3 | 54.5976 | 9.054 | 1.5503 | 75.49 | |
| 4 | 258.6524 | 1.000 | 1.7283 | 28.46 | |
| 5 | 39.1638 | 1.660 | | | |
| 6 | 45.1558 | 12.609 | 1.5928 | 68.62 | |
| 7 | −100.3906 | 1.000 | 1.9229 | 20.88 | |
| 8 | 119.0758 | 4.000 | | | |
| 9 | ∞ | (D9) | | | (Aperture |
| | | | | | Stop S) |
| 10 | 361.2899 | 1.000 | 1.5530 | 55.07 | |
| 11 | 47.0735 | (D11) | | | |
| 12 | −36.4250 | 1.300 | 1.6398 | 34.47 | |
| 13 | −49.6895 | 0.100 | | | |
| 14 | −131.6092 | 5.891 | 1.7292 | 54.67 | |
| 15 | −54.7849 | 0.100 | | | |
| 16 | 50.6772 | 14.609 | 1.7725 | 49.60 | |
| 17 | −230.5704 | (D17) | | | |
| 18 | 113.4024 | 1.000 | 1.8081 | 22.74 | |
| 19 | 52.3424 | (D19) | | | |
| 20 | 89.2568 | 1.000 | 1.9229 | 20.88 | |
| 21 | 36.4463 | 0.100 | | | |
| 22 | 36.3836 | 9.726 | 1.9591 | 17.47 | |
| 23 | 183.6004 | 8.074 | | | |
| 24 | −38.1283 | 1.000 | 1.7408 | 27.79 | |
| 25 | −98.0949 | 9.130 | | | |
| 26 | ∞ | 1.600 | 1.5168 | 63.88 | |
| 27 | ∞ | Bf | | | |

[Variable Distance Data]

| | | Upon focusing | Upon focusing on |
|---|---|---|---|
| | Upon focusing | on an intermediate | a very short |
| | on infinity | distance object | distance object |
| | f = 84.453 | β = −0.043 | β = −0.087 |
| D0 | ∞ | 2018.279 | 1007.763 |
| D9 | 2.000 | 6.974 | 12.784 |
| D11 | 21.625 | 16.651 | 10.841 |
| D17 | 2.000 | 4.186 | 6.592 |
| D19 | 9.109 | 6.923 | 4.518 |

[Lens Group Data]

| | First | Focal |
|---|---|---|
| Group | surface | length |
| G1 | 1 | 118.522 |
| G2 | 10 | −97.991 |
| G3 | 12 | 43.900 |
| G4 | 18 | −121.185 |
| G5 | 20 | −251.050 |

FIG. 8A shows graphs of various aberrations of the optical system upon focusing on infinity according to Fourth Example. FIG. 8B shows graphs of various aberrations of the optical system upon focusing on the short distance object according to Fourth Example. The various aberration graphs show that in the optical system according to Fourth Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Fifth Example

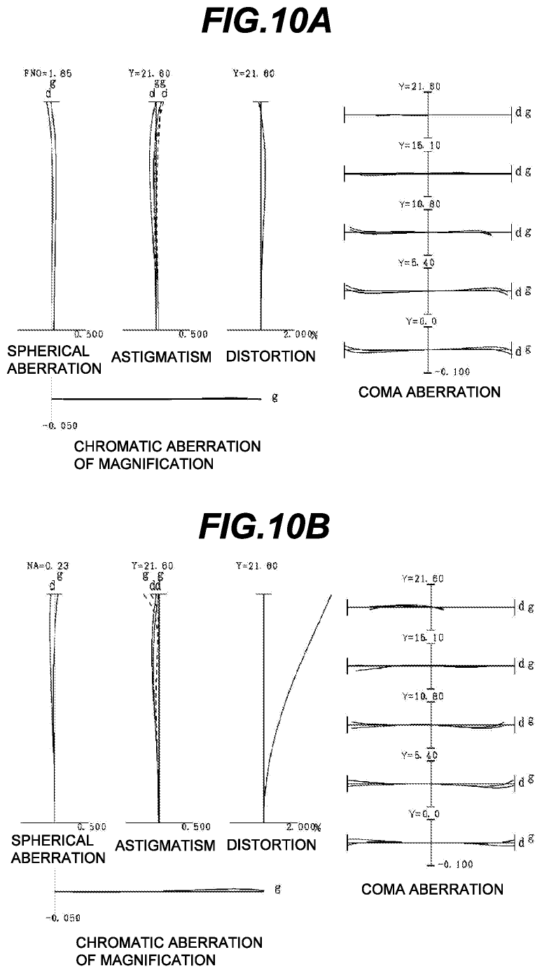

Fifth Example is described with reference to FIGS. 9 and FIGS. 10A and 10B and Table 5. FIG. 9 shows a lens configuration of an optical system according to Fifth Example. The optical system OL(5) according to Fifth Example consists of, in order from an object on the optical axis: a first lens group G1 having a positive refractive power; a second lens group G2 having a negative refractive power; a third lens group G3 having a positive refractive power; a fourth lens group G4 having a negative refractive power; and a fifth lens group G5 having a negative refractive power. Upon focusing from the infinity object to the short distance object, the second lens group G2 and the fourth lens group G4 move toward the image on the optical axis, and the distances between the lens groups adjacent to each other change. Note that upon focusing, the first lens group G1, the third lens group G3 and the fifth lens group G5 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a cemented lens including a biconvex positive lens L12, and a biconcave negative lens L13; and a cemented lens including a negative meniscus lens L14 having a convex surface facing the object, and a positive meniscus lens L15 having a convex surface facing the object. The second lens group G2 consists of, in order from the object, a cemented lens that has a negative refractive power and includes a positive meniscus lens L21 having a concave surface facing the object, and a biconcave negative lens L22.

The third lens group G3 consists of, in order from the object on the optical axis: a biconvex positive lens L31; and a negative meniscus lens L32 having a concave surface facing the object. The fourth lens group G4 consists of, in order from the object, a cemented lens that has a negative refractive power, and includes a biconvex positive lens L41, and a biconcave negative lens L42.

The fifth lens group G5 consists of, in order from the object on the optical axis: a cemented lens including a negative meniscus lens L51 having a convex surface facing the object, and a biconvex positive lens L52; and a negative meniscus lens L53 having a concave surface facing the object. An image surface I is disposed on the image side of the fifth lens group G5. A parallel plate PP is disposed between the fifth lens group G5 and the image surface I.

The following Table 5 lists values of data on the optical system according to Fifth Example.

TABLE 5
[General Data]

| | |
|---|---|
| f = 68.369 | fA = 75.680 |
| FNO = 1.850 | fR = 52.672 |
| 2ω = 35.083 | Δx = 11.502 |
| Y = 21.600 | βF = 6.768 |
| TL = 116.082 | βB = 0.903 |
| Bf = 1.000 | βR1 = 0.110 |
| Bf (a) = 11.055 | |

[Lens Data]

| Surface | | | | | |
|---|---|---|---|---|---|
| Number | R | D | nd | νd | |
| 1 | 113.3605 | 3.581 | 1.9229 | 18.90 | |
| 2 | 259.4789 | 2.000 | | | |
| 3 | 64.8154 | 7.756 | 1.7495 | 35.28 | |
| 4 | −305.8877 | 1.000 | 1.9229 | 18.90 | |
| 5 | 89.4171 | 9.650 | | | |
| 6 | 42.6939 | 1.000 | 1.9037 | 31.34 | |
| 7 | 24.8498 | 8.072 | 1.6584 | 50.88 | |
| 8 | 195.3643 | 2.647 | | | |
| 9 | ∞ | (D9) | | | (Aperture |
| | | | | | Stop S) |
| 10 | −123.7398 | 2.263 | 1.8590 | 22.73 | |
| 11 | −60.4222 | 1.000 | 1.5225 | 59.84 | |
| 12 | 34.0422 | (D12) | | | |
| 13 | 35.0724 | 8.638 | 1.6584 | 50.88 | |
| 14 | −72.0999 | 0.816 | | | |
| 15 | −53.1994 | 6.085 | 2.0033 | 28.27 | |
| 16 | −57.0661 | (D16) | | | |
| 17 | 200.0000 | 4.047 | 1.5503 | 75.50 | |
| 18 | −70.0000 | 1.000 | 1.7888 | 28.43 | |
| 19 | 88.7178 | (D19) | | | |
| 20 | 146.9186 | 1.000 | 1.7847 | 26.29 | |
| 21 | 35.2338 | 8.408 | 2.0010 | 29.14 | |
| 22 | −294.1634 | 5.492 | | | |
| 23 | −25.4180 | 1.000 | 1.6889 | 31.07 | |
| 24 | −199.9991 | 9.000 | | | |
| 25 | ∞ | 1.600 | 1.5168 | 63.88 | |
| 26 | ∞ | Bf | | | |

[Variable Distance Data]

| | | Upon focusing | Upon focusing on |
|---|---|---|---|
| | Upon focusing | on an intermediate | a very short |
| | on infinity | distance object | distance object |
| | f = 68.369 | β = −0.028 | β = −0.148 |
| D0 | ∞ | 2500.000 | 500.000 |
| D9 | 2.021 | 4.185 | 13.522 |
| D12 | 20.093 | 17.929 | 8.591 |
| D16 | 1.418 | 1.749 | 4.177 |
| D19 | 5.496 | 5.164 | 2.737 |

[Lens Group Data]

| | First | Focal |
|---|---|---|
| Group | surface | length |
| G1 | 1 | 75.680 |
| G2 | 10 | −59.462 |
| G3 | 13 | 39.475 |
| G4 | 17 | −105.696 |
| G5 | 20 | −171.475 |

FIG. 10A shows graphs of various aberrations of the optical system upon focusing on infinity according to Fifth Example. FIG. 10B shows graphs of various aberrations of the optical system upon focusing on the short distance object according to Fifth Example. The various aberration graphs show that in the optical system according to Fifth Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Sixth Example

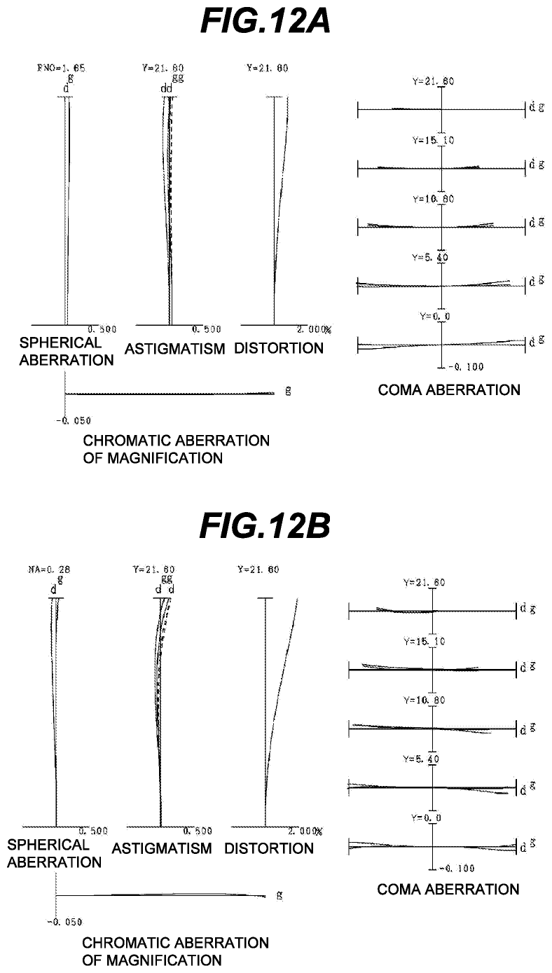

Sixth Example is described with reference to FIGS. 11 and FIGS. 12A and 12B and Table 6. FIG. 11 shows a lens configuration of an optical system according to Sixth Example. The optical system OL(6) according to Sixth Example consists of, in order from an object on the optical axis: a first lens group G1 having a positive refractive power; a second lens group G2 having a negative refractive power; a third lens group G3 having a positive refractive power; a fourth lens group G4 having a negative refractive power; and a fifth lens group G5 having a negative refractive power. Upon focusing from the infinity object to the short distance object, the second lens group G2 and the fourth lens group G4 move toward the image on the optical axis, and the distances between the lens groups adjacent to each other change. Note that upon focusing, the first lens group G1, the third lens group G3 and the fifth lens group G5 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a positive meniscus lens L12 having a convex surface facing the object; a cemented lens including a positive meniscus lens L13 having a convex surface facing the object, and a negative meniscus lens L14 having a convex surface facing the object; a negative meniscus lens L15 having a convex surface facing the object; and a positive meniscus lens L16 having a convex surface facing the object. The second lens group G2 consists of, in order from the object, a cemented lens that has a negative refractive power, and includes a negative meniscus lens L21 having a convex surface facing the object, and a negative meniscus lens L22 having a convex surface facing the object.

The third lens group G3 consists of, in order from the object on the optical axis: a cemented lens including a biconcave negative lens L31, and a biconvex positive lens L32; a positive meniscus lens L33 having a convex surface facing the object; and a biconvex positive lens L34. The fourth lens group G4 consists of a negative meniscus lens L41 having a convex surface facing the object.

The fifth lens group G5 consists of, in order from the object on the optical axis: a cemented lens including a biconvex positive lens L51, and a negative meniscus lens L52 having a concave surface facing the object; and a negative meniscus lens L53 having a concave surface facing the object. An image surface I is disposed on the image side of the fifth lens group G5. A parallel plate PP is disposed between the fifth lens group G5 and the image surface I.

The following Table 6 lists values of data on the optical system according to Sixth Example.

TABLE 6
[General Data]

| | |
|---|---|
| f = 79.983 | fA = 80.002 |
| FNO = 1.650 | fR = 58.141 |
| 2ω = 14.994 | Δx = 8.575 |
| Y = 21.600 | βF = 3.011 |
| TL = 127.000 | βB = 1.000 |
| Bf = 1.000 | βR1 = 0.280 |
| Bf (a) = 12.166 | |

[Lens Data]

| Surface | | | | | |
|---|---|---|---|---|---|
| Number | R | D | nd | νd | |
| 1 | 110.5878 | 4.985 | 1.9630 | 24.11 | |
| 2 | 283.6905 | 0.100 | | | |
| 3 | 63.6059 | 4.396 | 2.0033 | 28.27 | |
| 4 | 89.9017 | 3.000 | | | |
| 5 | 80.0000 | 5.550 | 1.6935 | 53.20 | |
| 6 | 383.6873 | 1.200 | 1.8929 | 20.36 | |
| 7 | 84.9195 | 5.586 | | | |
| 8 | 48.6443 | 1.000 | 1.8467 | 23.78 | |
| 9 | 28.2642 | 0.248 | | | |
| 10 | 28.4061 | 10.976 | 1.4970 | 81.61 | |
| 11 | 231.2679 | 2.922 | | | |
| 12 | ∞ | (D12) | | | (Aperture |
| | | | | | Stop S) |
| 13 | 267.2771 | 1.500 | 1.6230 | 58.16 | |
| 14 | 36.6616 | 3.000 | 1.8590 | 22.73 | |
| 15 | 35.7069 | (D15) | | | |
| 16 | −36.0649 | 1.000 | 1.7380 | 32.33 | |
| 17 | 92.6451 | 8.190 | 1.7725 | 49.62 | |
| 18 | −48.8133 | 0.100 | | | |
| 19 | 64.0592 | 4.832 | 1.7725 | 49.60 | |
| 20 | 306.9860 | 1.122 | | | |
| 21 | 88.0545 | 5.785 | 1.9229 | 20.88 | |
| 22 | −184.9624 | (D22) | | | |
| 23 | 140.5931 | 1.505 | 1.6910 | 54.82 | |
| 24 | 48.6168 | (D24) | | | |
| 25 | 83.3736 | 11.265 | 1.8515 | 40.78 | |
| 26 | −30.3564 | 1.000 | 1.8081 | 22.74 | |
| 27 | −217.6682 | 3.835 | | | |
| 28 | −42.0504 | 1.000 | 1.7783 | 23.91 | |
| 29 | −2185.7734 | 10.111 | | | |
| 30 | ∞ | 1.600 | 1.5168 | 63.88 | |
| 31 | ∞ | Bf | | | |

[Variable Distance Data]

| | | Upon focusing | Upon focusing on |
|---|---|---|---|
| | Upon focusing | on an intermediate | a very short |
| | on infinity | distance object | distance object |
| | f = 79.983 | β = −0.032 | β = −0.113 |
| D0 | ∞ | 2544.448 | 725.082 |
| D12 | 1.300 | 3.613 | 9.875 |
| D15 | 18.706 | 16.393 | 10.131 |
| D22 | 1.300 | 2.156 | 4.812 |
| D24 | 8.887 | 8.031 | 5.375 |

[Lens Group Data]

| | First | Focal |
|---|---|---|
| Group | surface | length |
| G1 | 1 | 80.002 |
| G2 | 13 | −67.065 |
| G3 | 16 | 41.282 |
| G4 | 23 | −108.270 |
| G5 | 25 | −1174.941 |

FIG. 12A shows graphs of various aberrations of the optical system upon focusing on infinity according to Sixth Example. FIG. 12B shows graphs of various aberrations of the optical system upon focusing on the short distance object according to Sixth Example. The various aberration graphs show that in the optical system according to Sixth Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Seventh Example

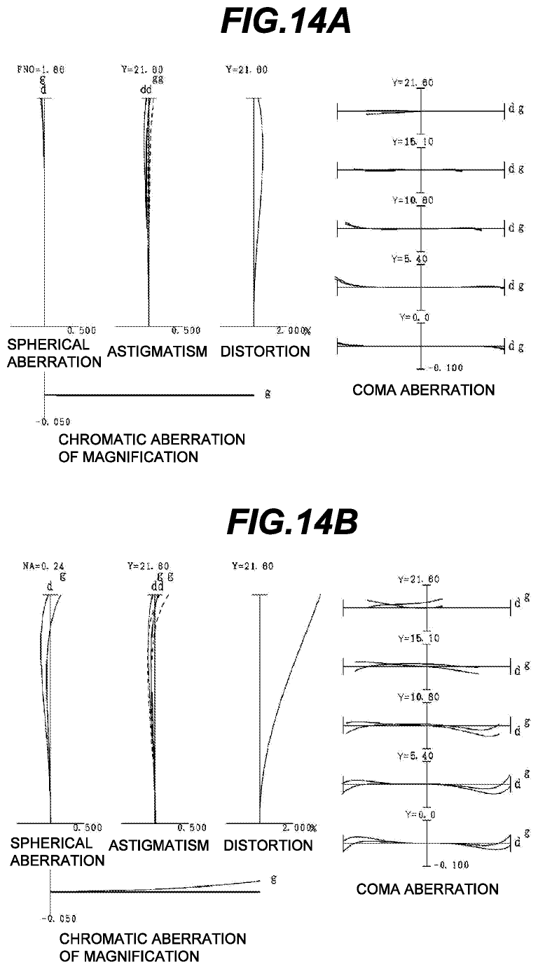

Seventh Example is described with reference to FIGS. 13 and FIGS. 14A and 14B and Table 7. FIG. 13 shows a lens configuration of an optical system according to Seventh Example. The optical system OL(7) according to Seventh Example consists of, in order from the object on the optical axis: a first lens group G1 having a positive refractive power; a second lens group G2 having a negative refractive power; and a third lens group G3 having a positive refractive power. Upon focusing from the infinity object to the short distance object, the second lens group G2 moves toward the image on the optical axis, and the distances between the lens groups adjacent to each other change. Note that upon focusing, the first lens group G1 and the third lens group G3 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2 and the third lens group G3 constitute the rear group GB. The second lens group G2 corresponds to the focusing lens group GF disposed closest to the object in the rear group GB. The third lens group G3 corresponds to the succeeding lens group GR1 disposed adjacent on the image surface side of the focusing lens group GF.

The first lens group G1 consists of, in order from the object on the optical axis: a positive meniscus lens L11 having a convex surface facing the object; a cemented lens including a biconvex positive lens L12, and a biconcave negative lens L13; and a cemented lens including a negative meniscus lens L14 having a convex surface facing the object, and a positive meniscus lens L15 having a convex surface facing the object. The second lens group G2 consists of, in order from the object, a cemented lens that has a negative refractive power and includes a positive meniscus lens L21 having a concave surface facing the object, and a biconcave negative lens L22.

The third lens group G3 consists of, in order from the object on the optical axis: a biconvex positive lens L31; a cemented lens including a biconcave negative lens L32, and a biconvex positive lens L33; a cemented lens including a biconvex positive lens L34, and a biconcave negative lens L35; a negative meniscus lens L36 having a convex surface facing the object; a biconvex positive lens L37; and a negative meniscus lens L38 having a concave surface facing the object. An image surface I is disposed on the image side of the third lens group G3. A parallel plate PP is disposed between the third lens group G3 and the image surface I.

The following Table 7 lists values of data on the optical system according to Seventh Example.

TABLE 7
[General Data]

| | |
|---|---|
| f = 73.180 | fA = 65.047 |
| FNO = 1.857 | fR = 61.979 |
| 2ω = 32.805 | Δx = 7.838 |
| Y = 21.600 | βF = 5.900 |
| TL = 119.318 | βB = 1.125 |
| Bf = 1.006 | βR1 = 0.191 |
| Bf (a) = 11.061 | |

[Lens Data]

| Surface | | | | | |
|---|---|---|---|---|---|
| Number | R | D | nd | νd | |
| 1 | 86.3436 | 3.855 | 1.9229 | 18.90 | |
| 2 | 240.9219 | 0.100 | | | |
| 3 | 109.1989 | 5.811 | 1.7495 | 35.28 | |
| 4 | −148.8703 | 1.000 | 1.9229 | 20.88 | |
| 5 | 100.0000 | 11.212 | | | |
| 6 | 40.0083 | 1.000 | 1.9037 | 31.31 | |
| 7 | 23.8536 | 8.324 | 1.6968 | 55.53 | |
| 8 | 541.8771 | 3.546 | | | |
| 9 | ∞ | (D9) | | | (Aperture |
| | | | | | Stop S) |
| 10 | −102.6387 | 2.695 | 1.8590 | 22.73 | |
| 11 | −47.9027 | 1.940 | 1.5530 | 55.07 | |
| 12 | 32.6973 | (D12) | | | |
| 13 | 34.2780 | 7.412 | 1.7015 | 41.24 | |
| 14 | −122.6095 | 0.204 | | | |
| 15 | −30343.0670 | 1.113 | 1.9537 | 32.32 | |
| 16 | 31.2978 | 6.189 | 1.7639 | 48.49 | |
| 17 | −1254.1635 | 1.400 | | | |
| 18 | 141.8350 | 5.000 | 1.5378 | 74.70 | |
| 19 | −48.4566 | 1.000 | 1.6398 | 34.47 | |
| 20 | 90.6288 | 2.112 | | | |
| 21 | 240.5167 | 1.001 | 1.8548 | 24.80 | |
| 22 | 37.9682 | 0.100 | | | |
| 23 | 37.4387 | 12.070 | 2.0007 | 25.46 | |
| 24 | −277.6337 | 5.753 | | | |
| 25 | −23.7721 | 1.076 | 1.6730 | 38.26 | |
| 26 | −96.5381 | 9.000 | | | |
| 27 | ∞ | 1.600 | 1.5168 | 63.88 | |
| 28 | ∞ | Bf | | | |

[Variable Distance Data]

| | | Upon focusing | Upon focusing |
|---|---|---|---|
| | Upon focusing | on an intermediate | on a very short |
| | on infinity | distance object | distance object |
| | f = 73.180 | β = −0.029 | β = −0.128 |
| D0 | ∞ | 2558.661 | 610.735 |
| D9 | 2.242 | 3.982 | 10.080 |
| D12 | 21.558 | 19.818 | 13.719 |

[Lens Group Data]

| | First | Focal |
|---|---|---|
| Group | surface | length |
| G1 | 1 | 65.047 |
| G2 | 10 | −52.462 |
| G3 | 13 | 61.979 |

FIG. 14A shows graphs of various aberrations of the optical system upon focusing on infinity according to Seventh Example. FIG. 14B shows graphs of various aberrations of the optical system upon focusing on the short distance object according to Seventh Example. The various aberration graphs show that in the optical system according to Seventh Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

### Eighth Example

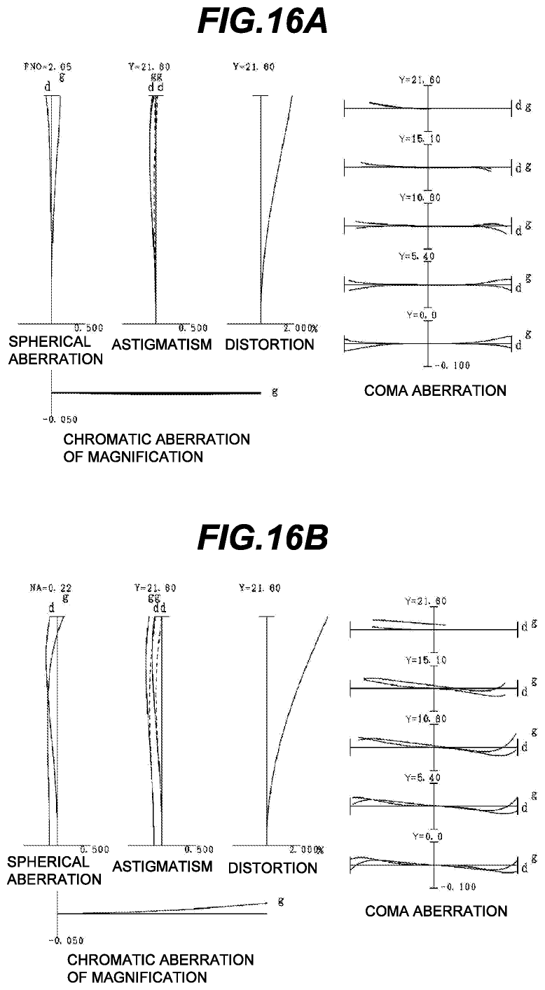

Eighth Example is described with reference to FIGS. 15 and 16A and 16B and Table 8. FIG. 15 shows a lens configuration of an optical system according to Eighth Example. The optical system OL(8) according to Eighth Example consists of, in order from an object on the optical axis: a first lens group G1 having a positive refractive power; a second lens group G2 having a negative refractive power; a third lens group G3 having a positive refractive power; a fourth lens group G4 having a positive refractive power; and a fifth lens group G5 having a negative refractive power. Upon focusing from the infinity object to the short distance object, the second lens group G2 moves toward the image on the optical axis, the fourth lens group G4 moves toward the object on the optical axis, and the distances between the lens groups adjacent to each other change. Note that upon focusing, the first lens group G1, the third lens group G3 and the fifth lens group G5 are fixed with respect to the image surface I.

The aperture stop S is disposed between the first lens group G1 and the second lens group G2. Upon focusing, the aperture stop S is fixed with respect to the image surface I. In this Example, the first lens group G1 constitutes the front group GA. The second lens group G2, the third lens group G3, the fourth lens group G4 and the fifth lens group G5 constitute the rear group GB. The second lens group G2 corresponds to the first focusing lens group GF1 disposed closest to the object in the rear group GB. The third lens group G3 corresponds to the succeeding lens group GR1 disposed adjacent on the image surface side of the first focusing lens group GF1. The fourth lens group G4 corresponds to the second focusing lens group GF2 disposed closer to the image surface than the first focusing lens group GF1.

The first lens group G1 consists of, in order from the object on the optical axis: a positive meniscus lens L11 having a convex surface facing the object; a positive meniscus lens L12 having a convex surface facing the object; and a cemented lens including a biconvex positive lens L13, and a biconcave negative lens L14. The second lens group G2 consists of a negative meniscus lens L21 having a convex surface facing the object.

The third lens group G3 consists of a biconvex positive lens L31. The fourth lens group G4 consists of a positive meniscus lens L41 having a convex surface facing the object.

The fifth lens group G5 consists of a negative meniscus lens L51 having a concave surface facing the object. An image surface I is disposed on the image side of the fifth lens group G5. A parallel plate PP is disposed between the fifth lens group G5 and the image surface I.

The following Table 8 lists values of data on the optical system according to Eighth Example.

TABLE 8
[General Data]

| | |
|---|---|
| f = 82.010 | fA = 84.922 |
| FNO = 2.050 | fR = 72.581 |
| 2ω = 32.753 | Δx = 8.605 |
| Y = 21.600 | βF = 3.508 |
| TL = 90.018 | βB = 0.966 |
| Bf = l.322 | βR1 = 0.219 |
| Bf (a) = 16.376 | |

[Lens Data]

| Surface | | | | | |
|---|---|---|---|---|---|
| Number | R | D | nd | νd | |
| 1 | 49.7600 | 5.102 | 1.7550 | 52.32 | |
| 2 | 207.7589 | 0.100 | | | |
| 3 | 43.3970 | 4.415 | 1.6180 | 63.33 | |
| 4 | 120.3692 | 0.100 | | | |
| 5 | 35.5101 | 6.189 | 1.5928 | 68.62 | |
| 6 | −216.6911 | 2.098 | 1.9053 | 35.04 | |
| 7 | 28.2895 | 5.240 | | | |
| 8 | ∞ | (D8) | | | (Aperture |
| | | | | | Stop S) |
| 9 | 5405.8128 | 1.000 | 1.4875 | 70.23 | |
| 10 | 35.3627 | (D10) | | | |
| 11 | 41.2560 | 9.000 | 1.5174 | 52.43 | |
| 12 | −51.9830 | (D12) | | | |
| 13 | 98.4043 | 2.467 | 1.8590 | 22.73 | |
| 14 | 222.8980 | (D14) | | | |
| 15 | −31.6093 | 3.000 | 1.8502 | 30.05 | |
| 16 | −173.6461 | 14.000 | | | |
| 17 | ∞ | 1.600 | 1.5168 | 63.88 | |
| 18 | ∞ | Bf | | | |

[Variable Distance Data]

| | | Upon focusing | Upon focusing |
|---|---|---|---|
| | Upon focusing | on an intermediate | on a very short |
| | on infinity | distance object | distance object |
| | f = 82.010 | β = −0.033 | β = −0.115 |
| D0 | ∞ | 2526.094 | 756.181 |
| D8 | 1.985 | 4.234 | 10.591 |
| D10 | 16.324 | 14.075 | 7.719 |
| D12 | 10.523 | 8.452 | 4.434 |
| D14 | 5.552 | 7.623 | 11.641 |

[Lens Group Data]

| | First | Focal |
|---|---|---|
| Group | surface | length |
| G1 | 1 | 84.922 |
| G2 | 9 | −73.023 |
| G3 | 11 | 45.967 |
| G4 | 13 | 203.256 |
| G5 | 15 | −45.895 |

FIG. 16A shows graphs of various aberrations of the optical system upon focusing on infinity according to Eighth Example. FIG. 16B shows graphs of various aberrations of the optical system upon focusing on the short distance object according to Eighth Example. The various aberration graphs show that in the optical system according to Eighth Example, over the entire range from focusing on infinity to focusing on the short distance object, the various aberrations are favorably corrected, and an excellent imaging performance is achieved. Accordingly, even upon focusing on the short distance object, the fluctuation in angle of view upon focusing can be reduced while maintaining a favorable optical performance.

Next, the table of [Conditional Expression Corresponding Value] is shown below. This table collectively indicates values corresponding to the conditional expressions (1) to (16) with respect to all the examples (First to Eighth Examples).

0.50<ST/TL<0.95 Conditional Expression (1)

0.65<(−fF)/fA<1.20 Conditional Expression (2)

0.70<(−fF)/fR<1.80 Conditional Expression (3)

0.00<βR1/βF<0.25 Conditional Expression (4)

0.03<Δx/f<0.35 Conditional Expression (5)

0.65<f/(−fF)<1.60 Conditional Expression (6)

2.00<TL/(FNO×Bf)<10.00 Conditional Expression (7)

−2.50<(rFR2+rFR1)/(rFR2−rFR1)<−0.25 Conditional Expression (8)

0.90<(rNR2+rNR1)/(rNR2−rNR1)<2.65 Conditional Expression (9)

0.08<1/βF<0.55 Conditional Expression (10)

{βF+(1/βF)}⁻²<0.15 Conditional Expression (11)

0.003<BLDF/TL<0.060 Conditional Expression (12)

0.05<βB/βF<0.50 Conditional Expression (13)

0.05<Bf/TL<0.25 Conditional Expression (14)

1.00<FNO<3.00 Conditional Expression (15)

12.00°<2ω<40.00° Conditional Expression (16)

[Conditional Expression Corresponding Value] (First to Fourth Example)

| Conditional | First | Second | Third | Fourth |
|---|---|---|---|---|
| Expression | Example | Example | Example | Example |
| (1) | 0.702 | 0.667 | 0.747 | 0.695 |
| (2) | 0.914 | 0.794 | 1.070 | 0.827 |
| (3) | 1.268 | 0.950 | 1.335 | 1.598 |
| (4) | 0.138 | 0.038 | 0.081 | 0.040 |
| (5) | 0.146 | 0.095 | 0.127 | 0.128 |
| (6) | 1.065 | 1.275 | 0.748 | 0.862 |
| (7) | 8.113 | 5.488 | 2.447 | 9.359 |
| (8) | −1.192 | −1.054 | −2.198 | −1.300 |
| (9) | 1.661 | 1.441 | 2.433 | 2.272 |
| (10) | 0.384 | 0.227 | 0.401 | 0.265 |
| (11) | 0.112 | 0.047 | 0.119 | 0.061 |
| (12) | 0.009 | 0.011 | 0.011 | 0.008 |
| (13) | 0.374 | 0.230 | 0.321 | 0.188 |
| (14) | 0.087 | 0.098 | 0.198 | 0.086 |
| (15) | 1.424 | 1.855 | 2.060 | 1.242 |
| (16) | 28.285 | 28.002 | 28.969 | 28.622 |

[Conditional Expression Corresponding Value] (Fifth to Eighth Example)

| Conditional | Fifth | Sixth | Seventh | Eighth |
|---|---|---|---|---|
| Expression | Example | Example | Example | Example |
| (1) | 0.692 | 0.685 | 0.708 | 0.742 |
| (2) | 0.786 | 0.838 | 0.807 | 0.860 |
| (3) | 1.129 | 1.154 | 0.846 | 1.006 |
| (4) | 0.016 | 0.093 | 0.032 | 0.062 |
| (5) | 0.168 | 0.107 | 0.107 | 0.105 |
| (6) | 1.150 | 1.193 | 1.395 | 1.123 |
| (7) | 5.676 | 6.327 | 5.808 | 2.681 |
| (8) | −0.568 | −1.308 | −0.517 | −1.013 |
| (9) | 1.291 | 1.039 | 1.653 | 1.445 |
| (10) | 0.148 | 0.332 | 0.169 | 0.285 |
| (11) | 0.021 | 0.089 | 0.027 | 0.070 |
| (12) | 0.028 | 0.035 | 0.039 | 0.011 |
| (13) | 0.133 | 0.332 | 0.191 | 0.275 |
| (14) | 0.095 | 0.096 | 0.093 | 0.182 |
| (15) | 1.850 | 1.650 | 1.857 | 2.050 |
| (16) | 35.083 | 14.994 | 32.805 | 32.753 |

According to each Examples described above, the optical systems having small fluctuation in angle of view upon focusing can be achieved.

Each of the aforementioned Examples describes a specific example of the invention of the present application. The invention of the present application is not limited to these Examples.

The following content can be adopted in a range without impairing the optical performance of the optical system according to the present embodiment.

The three-group configurations and five-group configurations are described as Examples of the optical systems according to the present embodiment. However, the present application is not limited to these configurations. An optical system having another group configuration (e.g., a four- or six-group one, etc.) may be configured. Specifically, a configuration may be adopted where a lens or a lens group is added to a position closest to the object or a position closest to the image surface in the optical system in the present embodiment. Note that the lens group indicates a portion that includes at least one lens separated by air distances that change during focusing.

A vibration-proof lens group that moves a lens group or a partial lens group so as to have a component in a direction perpendicular to the optical axis, or rotationally moves (swings) the lens group or the partial lens group in a direction in a plane including the optical axis, and corrects an image blur caused by camera shakes, may be configured.

The lens surface may be made of a spherical surface or a planar surface, or an aspherical surface. A case where the lens surface is a spherical surface or a planar surface is preferable, because lens processing, and assembling and adjustment are facilitated, and the optical performance degradation due to errors caused by processing and assembling and adjustment can be prevented. It is also preferable because the degradation in representation performance is small even with a possible misaligned image surface.

In the cases where the lens surface is an aspherical surface, the aspherical surface may be any of an aspherical surface made by a grinding process, a glass mold aspherical surface made by forming glass into an aspherical shape with a mold, and a composite type aspherical surface made by forming a resin on a surface of glass into an aspherical shape. The lens surface may be a diffractive surface. The lens may be a gradient-index lens (GRIN lens), or a plastic lens.

Preferably, the aperture stop is disposed between the first lens group and the second lens group. Alternatively, a member as an aperture stop is not necessarily provided, and a lens frame may serve as what has the function instead.

An antireflection film having a high transmissivity in a wide wavelength region may be applied onto each lens surface in order to reduce flares and ghosts and achieve optical performances having a high contrast.

EXPLANATION OF NUMERALS AND CHARACTERS

| | |
|---|---|
| G1 First lens group | G2 Second lens group |
| G3 Third lens group | G4 Fourth lens group |
| G5 Fifth lens group | |
| I Image surface | S Aperture stop |

1. An optical system consisting of, in order from an object on an optical axis: a front group; an aperture stop; and a rear group,
wherein the rear group comprises a focusing lens group that is disposed closest to the object in the rear group, and has a negative refractive power,
upon focusing, the focusing lens group moves on the optical axis, and distances between lens groups adjacent to each other change, and
the following conditional expression is satisfied,
0.50<ST/TL<0.95
where ST: a distance from the aperture stop to an image surface on the optical axis, and
TL: an entire length of the optical system.

2. The optical system according to claim 1,
wherein the following conditional expression is satisfied,
0.65<(−fF)/fA<1.20
where fF: a focal length of the focusing lens group, and
fA: a focal length of the front group.

3. The optical system according to claim 1,
wherein the rear group comprises at least one lens group disposed closer to the image surface than the focusing lens group, and
the following conditional expression is satisfied,
0.70<(−fF)/fR<1.80
where fF: a focal length of the focusing lens group, and
fR: a combined focal length of the at least one lens group.

4. The optical system according to claim 1,
wherein the rear group comprises a succeeding lens group disposed adjacent on an image side of the focusing lens group, and
the following conditional expression is satisfied,
0.00<βR1/βF<0.25
where βR1: a lateral magnification of the succeeding lens group upon focusing on an infinity object, and
βF: a lateral magnification of the focusing lens group upon focusing on the infinity object.

5. The optical system according to claim 1,
wherein the following conditional expression is satisfied,
0.03<Δx/f<0.35
where Δx: an amount of movement of the focusing lens group upon focusing from an infinity object to a short distance object, and
f: a focal length of the optical system.

6. The optical system according to claim 1,
wherein the following conditional expression is satisfied,
0.65<f/(−fF)<1.60
where f: a focal length of the optical system, and
fF: a focal length of the focusing lens group.

7. The optical system according to claim 1,
wherein the following conditional expression is satisfied,
2.00<TL/(FNO×Bf)<10.00
where FNO: an f-number of the optical system, and
Bf: a back focus of the optical system.

8. The optical system according to claim 1, wherein the focusing lens group consists of one negative lens component.

9. The optical system according to claim 1,
wherein the following conditional expression is satisfied,
−2.50<(rFR2+rFR1)/(rFR2−rFR1)<−0.25
where rFR1: a radius of curvature of a lens surface closest to the object in the focusing lens group, and
rFR2: a radius of curvature of a lens surface closest to the image surface in the focusing lens group.

10. The optical system according to claim 1,
wherein the following conditional expression is satisfied,
0.90<(rNR2+rNR1)/(rNR2−rNR1)<2.65
where rNR1: a radius of curvature of an object-side lens surface of a lens of the optical system that is disposed closest to the image surface, and
rNR2: a radius of curvature of an image-side lens surface of a lens of the optical system that is disposed closest to the image surface.

11. The optical system according to claim 1,
wherein the following conditional expression is satisfied,
0.08<1/βF<0.55
where βF: a lateral magnification of the focusing lens group upon focusing on the infinity object.

12. The optical system according to claim 1,
wherein the following conditional expression is satisfied,
{βF+(1/βF)}⁻²<0.15
where βF: a lateral magnification of the focusing lens group upon focusing on the infinity object.

13. The optical system according to claim 1,
wherein the following conditional expression is satisfied,
0.003<BLDF/TL<0.060
where BLDF: a length of the focusing lens group on the optical axis.

14. The optical system according to claim 1,
wherein the following conditional expression is satisfied,
0.05<βB/βF<0.50
where βB: a lateral magnification of the rear group upon focusing on an infinity object, and
βF: a lateral magnification of the focusing lens group upon focusing on the infinity object.

15. The optical system according to claim 1,
wherein the following conditional expression is satisfied,
0.05<Bf/TL<0.25
where Bf: a back focus of the optical system.

16. The optical system according to claim 1,
wherein the following conditional expression is satisfied,
1.00<FNO<3.00
where FNO: an f-number of the optical system.

17. The optical system according to claim 1,
wherein the following conditional expression is satisfied,
12.00°<2ω<40.00°
where 2ω: a full angle of view of the optical system.

18. An optical apparatus comprising the optical system according to claim 1.

19. A method for manufacturing an optical system consisting of, in order from an object on an optical axis: a front group; an aperture stop; and a rear group, comprising a step of disposing the front group, the aperture stop and the rear group in a lens barrel so that;
the rear group comprises a focusing lens group that is disposed closest to the object in the rear group, and has a negative refractive power,
upon focusing, the focusing lens group moves on the optical axis, and distances between lens groups adjacent to each other change, and
the following conditional expression is satisfied,
0.50<ST/TL<0.95
where ST: a distance from the aperture stop to an image surface on the optical axis, and
TL: an entire length of the optical system.
